(19) United States
(12) Patent Application Publication
(10) Pub. No.: US 2007/0231467 A1
(43) Pub. Date: Oct. 4, 2007

(54) METHOD FOR MANUFACTURING LIGHT EMITTING DEVICE AND METHOD FOR MANUFACTURING ELECTRONIC APPARATUS

(75) Inventors: Takeshi TAKASHIMA, Kawasaki-shi (JP); Koichi TERAO, Suwa-shi (JP); Takashi SHINOHARA, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/688,128

(22) Filed: Mar. 19, 2007

(30) Foreign Application Priority Data
Mar. 20, 2006 (JP) 2006-077832

(51) Int. Cl. B05D 5/06; B05D 5/12

(52) U.S. Cl. 427/66; 427/64

(57) ABSTRACT

A method for manufacturing a light emitting device includes :forming a first coated film including a light emitting compound and a carrier transporting compound on a surface of a first electrode, the light emitting compound including a light emitting moiety that has luminescent characteristics emitting light of a first color and a polymerizable group that has photopolymerization characteristics and the carrier transporting compound including a carrier transporting moiety that has carrier transporting characteristics and a polymerizable group that has photopolymerization characteristics; forming a first light emitting layer by polymerizing between the compounds in the first coated film under light irradiation on the first coated film to harden a light-irradiated region thereon; removing a region other than the light-irradiated region on the first coated film; forming a second coated film including a light emitting compound and a carrier transporting compound on the surface of the first electrode, the light emitting compound including a light emitting moiety that has luminescent characteristics emitting light of a second color different from the first color and a polymerizable group that has photopolymerization characteristics and the carrier transporting compound including a carrier transporting moiety that has carrier transporting characteristics and a polymerizable group that has photopolymerization characteristics; forming a second light emitting layer by polymerizing between the compounds in the second coated film under light irradiation on the second coated film to harden a light-irradiated region thereon; removing a region other than the light-irradiated region on the second coated film; and providing a second electrode on a side opposite to the first electrode having the light emitting layers.

### BACKGROUND

1. Technical Field

Several aspects of the present invention relate to a method for manufacturing a light emitting device and a method for manufacturing an electronic apparatus

2. Related Art

An organic electroluminescent (EL) element (light emitting element) is provided with an organic EL layer (light emitting layer) including at least a light emitting organic compound is interposed between a cathode and an anode. The element allows light emission using light (fluorescence or phosphorescence) released upon deactivation of excitons, which are generated by the recombination of electrons and holes injected in the organic EL layer.

Such an organic EL element, for example, can achieve surface light emission with a high level of brightness of approximately 100 to 100, 000 cd/m² at a low voltage of equal to or less than 10V, as well as can emit light ranging from blue to red in accordance with the kinds of light emitting material selected. The organic EL element has been paid attention as the light emitting element that is incorporated in a display device (light emitting device) capable of large-area full-color display at a low cost.

As a full-color display device using the above organic EL element, JP-A-10-153967 discloses a structure in which a plurality of organic EL elements is provided on a substrate to emit red, green and blue lights.

In the full-color display device mentioned above, organic EL layers, which emit individual color (red, green and blue) lights, can be formed as follows: First, a bank is formed on a substrate with electrodes provided thereon. The bank has openings corresponding to shapes of the organic EL layers. Then, a liquid material (ink) that contains a light emitting material corresponding to each color is supplied to each opening by an inkjet method and then the ink is dried.

However, in order to supply ink by the inkjet method, viscosity and surface tension thereof are needed to be maintained (controlled) within suitable ranges. Therefore, there arises a problem of narrowing selection ranges for light emitting materials and solvents to be used.

Additionally, in order to control the viscosity and surface tension of ink, there is proposed a method for adding controlling agents thereto. In this case, however, those agents can change or deteriorate the quality of the light emitting material over time.

### SUMMARY

An advantage of the present invention is to provide a method for manufacturing a light emitting device, in which at least two light emitting layers emitting different color lights can be formed into a desired shape without providing a bank. Another advantage of the invention is to provide a method for manufacturing a highly reliable electronic apparatus, the method including the above method for manufacturing a light emitting device.

The above advantages can be achieved by typical aspects and forms of the invention described below.

According to a first aspect of the invention, a method for manufacturing a light emitting device includes: forming a first coated film including a light emitting compound and a carrier transporting compound on a surface of a first electrode, the light emitting compound including a light emitting moiety that has luminescent characteristics emitting light of a first color and a polymerizable group that has photopolymerization characteristics and the carrier transporting compound including a carrier transporting moiety that has carrier transporting characteristics and a polymerizable group that has photopolymerization characteristics; forming a first light emitting layer by polymerizing between the compounds in the first coated film under light irradiation on the first coated film to harden a light-irradiated region thereon; removing a region other than the light-irradiated region on the first coated film; forming a second coated film including a light emitting compound and a carrier transporting compound on the surface of the first electrode, the light emitting compound including a light emitting moiety that has luminescent characteristics emitting light of a second color different from the first color and a polymerizable group that has photopolymerization characteristics and the carrier transporting compound including a carrier transporting moiety that has carrier transporting characteristics and a polymerizable group that has photopolymerization characteristics; forming a second light emitting layer by polymerizing between the compounds in the second coated film under light irradiation on the second coated film to harden a light-irradiated region thereon; removing a region other than the light-irradiated region on the second coated film; and providing a second electrode on a side opposite to the first electrode having the light emitting layers.

In the manufacturing method according to the above aspect, at least two light emitting layers emitting lights of different colors can be formed into a desired shape without providing a bank.

In this method, preferably, a liquid phase process is used to form the first coated film.

This is because the liquid phase process allows easier formation of the first coated film, without any need for large equipment. In the process, a liquid material containing the light emitting compound and the carrier transporting compound is supplied on one surface of the electrode.

Additionally, in the method according to the first aspect, preferably, a weight ratio between the compounds in the first coated film is in a range from 1:100 to 90:10.

The weight ratio set within the above range can ensure that carriers injected from the electrodes can be supplied to the light emitting moiety through the carrier transporting moiety in the formed first light emitting layer. This can improve the efficiency of carrier injection into the light emitting moiety.

Additionally, in the method according to the first aspect, preferably, the polymerizable group included in at least one of the compounds in the first coated film includes a plurality of polymerizable groups.

In this manner, the shape of a random copolymer included in the first light emitting layer is not linear, namely, not straight-chained. It has a structure of molecules linked in a network, that is, a three-dimensional network structure. This can improve a thermal resistance of the first light emitting layer and the efficiency of the carrier injection into the light emitting moiety.

Additionally, in the method according to the first aspect, preferably, the polymerizable groups included in the compounds in the first coated film have cationic polymerization characteristics.

In this manner, the polymerizable groups included in both compounds show homogenous reactivities. Therefore, a randomization between the compounds can be further ensured.

Furthermore, in the method according to the first aspect, preferably, the polymerizable groups included in the compounds in the first coated film have radical polymerization characteristics.

In this manner, the polymerizable groups included in both compounds show homogeneous reactivities. Therefore, the randomization between the compounds can be further ensured.

Additionally, in the method according to the first aspect, preferably, the carrier transporting compound used in the first light emitting layer includes a hole transporting compound that includes a hole transporting portion having hole transporting characteristics and an electron transporting compound that includes an electron transporting portion having electron transporting characteristics.

In this manner, holes and electrons can more efficiently be injected into the light emitting moiety. This can further ensure luminescence of the light emitting moiety.

Additionally, in the above method, preferably, the hole transporting portion includes an arylamine skeleton.

This is because the hole transporting portion including the arylamine skeleton can exhibit especially excellent hole transporting characteristics and can relatively easily introduce (link) a polymerizable group thereto.

Additionally, in the above method, preferably, the electron transporting portion includes one of an oxadiazole skeleton and a triazole skeleton.

This is because the electron transporting portion including one of those skeletons can exhibit especially excellent electron transporting characteristics and can relatively easily introduce (link) a polymerizable group thereto.

In the method according to the first aspect, preferably, the light emitting moiety used in the first light emitting layer includes one of a fluorene skeleton and a carbazole skeleton.

This is because the light emitting moiety including one of the skeletons can exhibit especially excellent luminescent characteristics, as well as can relatively easily introduce (link) a polymerizable group thereto.

Additionally, in the method according to the first aspect, preferably, the light emitting moiety used in the first light emitting layer includes one of an iridium complex and an aluminum complex.

This is because the light emitting moiety including one of the complexes can show especially excellent luminescent characteristics, as well as can relatively easily introduce (link) a polymerizable group thereto.

In the method according to the first aspect, preferably, a liquid phase process is used to form the second coated film.

This is because the liquid phase process allows easier formation of the second coated film, without using large equipment. In the process, a liquid material containing the light emitting compound and the carrier transporting compound is supplied on one surface of the electrode.

In the method according to the first aspect, preferably, a weight ratio between the compounds in the second coated film is in a range from 1:100 to 90:10.

The weight ratio set within the above range can ensure that carriers injected from the electrodes are supplied to the light emitting moiety through the carrier transporting moiety in the formed second light emitting layer. This can improve the efficiency of carrier injection into the light emitting moiety.

In the method according to the first aspect, preferably, the polymerizable group included in at least one of the compounds in the second coated film includes a plurality of polymerizable groups.

In this manner, the shape of a random copolymer included in the second light emitting layer is not linear, namely, not straightly chained. The copolymer has a structure of molecules linked in a network, that is, a three-dimensional network structure. This can improve a thermal resistance of the second light emitting layer and the efficiency of carrier injection into the light emitting moiety.

In the method according to the first aspect, preferably, the polymerizable groups included in the compounds in the second coated film have cationic polymerization characteristics.

In this manner, the polymerizable groups included in both compounds show homogeneous reactivities. Therefore, the randomization between the compounds can be further ensured.

In the method according to the first aspect, preferably, the polymerizable groups included in the compounds in the second coated film have radical polymerization characteristics.

In this manner, the polymerizable groups included in both compounds show homogeneous reactivities. Therefore, the randomization between the compounds can be further ensured.

In the method according to the first aspect, preferably, the carrier transporting compound used in the second light emitting layer includes a hole transporting compound that includes a hole transporting portion having hole transporting characteristics and an electron transporting compound that includes an electron transporting portion having electron transporting characteristics.

In this manner, holes and electrons can more efficiently injected into the light emitting moietieso that the luminescence of the light emitting moiety can be further ensured.

Additionally, in the above method, preferably, the hole transporting portion includes an arylamine skeleton.

This is because the hole transporting portion including the arylamine skeleton can exhibit especially excellent hole transporting characteristics, as well as can relatively easily introduce (link) a polymerizable group thereto.

Additionally, in the above method, preferably, the electron transporting portion includes one of an oxadiazole skeleton and a triazole skeleton.

This is because the electron transporting portion including one of the skeletons can exhibit especially excellent electron transporting characteristics, as well as can relatively easily introduce (link) a polymerizable group thereto.

In the method according to the first aspect, preferably, the light emitting moiety used in the second light emitting layer includes one of a fluorene skeleton and a carbazole skeleton.

This is because the light emitting moiety including one of the skeletons can show especially excellent luminescent characteristics and can relatively easily introduce (link) a polymerizable group thereto.

In the method according to the first aspect, preferably, the light emitting moiety used in the second light emitting layer includes one of an iridium complex and an aluminum complex.

This is because the light emitting moiety including one of the complexes can show especially excellent luminescent characteristics, as well as can relatively easily introduce (link) a polymerizable group thereto.

In the method according to the first aspect, preferably, at least one of the first and second coated films includes a host compound having a host portion for supplying excitation energy to the light emitting moiety.

In this manner, in at least one of the first and second light emitting layers formed, it is possible to ensure reduction in energy loss of the host portion caused due to the recombination of holes and electrons. Therefore, luminescence efficiency of the light emitting moiety can be improved.

Additionally, in the above method, preferably, the host compound includes a polymerizable group.

In this manner, in at least one of the first and second light emitting layers formed, a random copolymer can be generated by polymerization among the light emitting compound, the carrier transporting compound and the host compound.

Additionally, in the above method, preferably, the host compound includes one of an arylamine skeleton, a carbazole skeleton and a fluorene skeleton.

This is because the host portion including one of the skeletons can have an especially large band gap.

According to a second aspect of the invention, a method for manufacturing an electronic apparatus includes the method for manufacturing a light emitting device according to the first aspect.

In this manner, a highly reliable electronic apparatus can be manufactured.

### BRIEF DESCRIPTION OF THE DRAWINGS

The invention will be described with reference to the accompanying drawings, wherein like numbers reference like elements.

FIG. 1 is a longitudinal sectional view of an active matrix light emitting device obtained by a method for manufacturing a light emitting device according to an embodiment of the invention.

FIG. 2 is a plan view showing a layout of organic EL layers included in the active matrix light emitting device shown in FIG. 1.

FIGS. 3A and 3B are plan views showing other layouts of the organic EL layers.

FIGS. 4A to 4D are longitudinal sectional views successively illustrating the method for manufacturing the active matrix light emitting device shown in FIG. 1.

FIGS. 6A to 5D are also longitudinal sectional views successively illustrating the above manufacturing method, following FIGS. 4A to 4D.

FIG. 6 is a perspective view showing a structure of a mobile (notebook) personal computer including the light emitting device shown above.

FIG. 7 is a perspective view showing a structure of a mobile phone (including PHS) including the above light emitting device.

FIG. 8 is a perspective view showing a structure of a digital still camera including the above light emitting device.

### DESCRIPTION OF EXEMPLARY EMBODIMENT

Hereinafter, an exemplary embodiment of the invention will be described with reference to the accompanying drawings.

Light Emitting Device

First, a description will be given of a light emitting device (active matrix light emitting device) obtained by a method for manufacturing a light emitting device according to an exemplary embodiment of the invention.

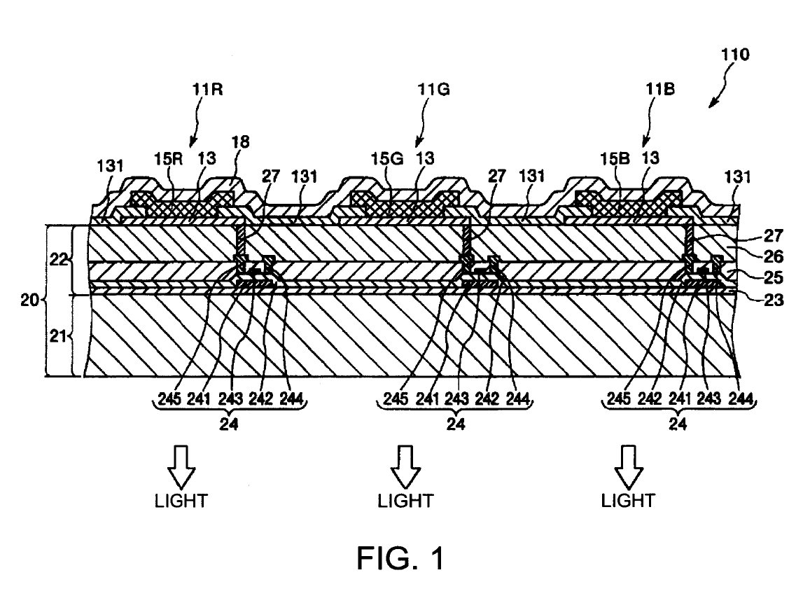

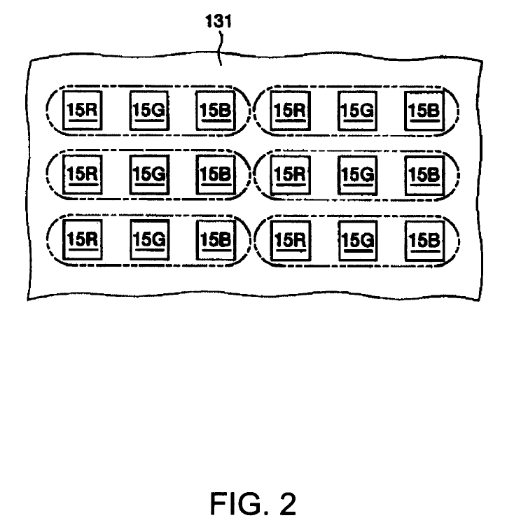

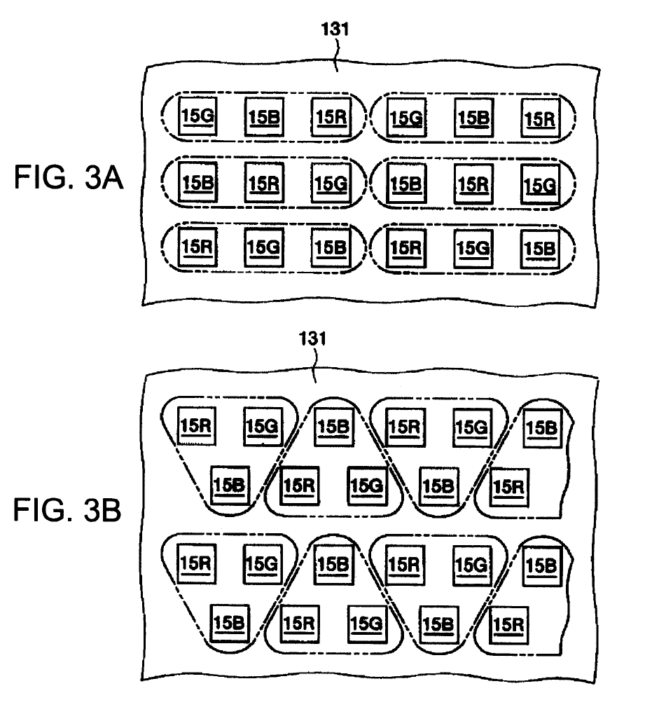

FIG. 1 is a longitudinal sectional view of the active matrix light emitting device obtained by the method for manufacturing a light emitting device according to the embodiment. In addition, FIG. 2 is a plan view showing a layout of organic EL layers included in the active matrix light emitting device shown in FIG. 1. FIGS. 3A and 3B are plan views showing other layouts of the organic EL layers. In the description below, upper and lower sides in FIG. 1 will be regarded as “upper” and “lower”, respectively, for convenience of explanation.

FIG. 1 shows an active matrix light emitting device (hereinafter simply referred to as a “light emitting device”) 110. The light emitting device 110 includes a thin-film transistor (TFT) circuit substrate 20 having a red (R) light emitting element 11R, a green (G) light emitting element 11G and a blue (B) light emitting element 11B provided thereon.

The TFT circuit substrate 20 has a substrate 21 with a circuit section 22 formed thereon.

The substrate 21 serves as a supporting body for individual parts included in the light emitting device 110.

Additionally, since the light emitting device 110 according to the embodiment is configured to emit light from the substrate 21-side, it is a bottom emission type of device. Thus, the substrate 21 is substantially transparent (colorless, colored transparent or semi-transparent).

The substrate 21 may be made of a solid or flexible substrate.

As the solid substrate, for example, it is possible to suitably use any one of glass substrates, ceramic substrates, semiconductor substrates and highly solid resin substrates.

Meanwhile, the flexible substrate may be made mainly of a material such as polyimide resin, polyester resin, polyamide resin or polyether resin including polyether ether ketone and polyethersulphone. Among them, polyimide resin has smaller coefficients of thermal expansion and thermal contraction. Accordingly, using a substrate made mainly of polyimide resin can reduce the thermal contraction coefficient thereof Additionally, a substrate made mainly of polyester resin has an advantage of having good size stability.

Furthermore, the contraction coefficient of the flexible substrate may be reduced by laminating such a resin material with a filler and a fiver added thereto or controlling a pre-thermal treatment and a degree of cross-linkage, so that size stability can be improved.

A mean thickness of the substrate 21 is not specifically limited, but it preferably ranges from approximately 1 to 30 mm, and more preferably, from approximately 5 to 20 mm.

The circuit section 22 has an underlying protective layer 23, which is formed on the substrate 21, driving TFTs (switching elements) 24 formed on the underlying protective layer 23 and first and second interlayer insulating layers 25 and 26.

Each of the driving TFTs 24 has a semiconductor layer 241, a gate insulating layer 242 formed thereon, a gate electrode 243 formed on the gate insulating layer 242, a source electrode 244 and a drain electrode 245.

On the circuit section 22 are provided the light emitting elements 11R, 11G and 11B, each of which corresponds to each driving TFT 24.

In the present embodiment, an anode 13 of each of the light emitting elements 11R, 11G and 11B forms each electrode (pixel electrode) and is electrically connected to the drain electrode 245 of each driving TFT 24 by a wire (conducting portion) 27.

In addition, organic EL layers 15R, 15G and 15B of the adjacent light emitting elements 11R, 11G and 11B are partitioned from each other in a manner corresponding to the anode 13 as each electrode. Those EL layers are arranged in a matrix form on a two-dimensional view (See FIG. 2). Specifically, each of the organic EL layers 15R, 15G and 15B is located in a range from a part on the anode 13 to parts on partitions 131, and are individually arranged without contacting with each other.

Furthermore, in FIG. 2, a single pixel includes three light emitting elements 11R, 11G and 11B, which are shown as a part surrounded by a two-dot chain line.

A layout of the organic EL layers 15R, 15G and 15B is not limited to that shown in FIG. 2 and may be one of those shown in FIGS. 3A and 3B, for example.

Sizes (based on the two-dimensional view) of the organic EL layers 15R, 15G and 15B are approximately equal. This facilitates formation thereof. Consequently, the method for manufacturing the light emitting device 110 can be simplified and the manufacturing cost thereof can be reduced.

Hereinafter, a detailed explanation will be given as to the light emitting elements 11R, 11G and 11B.

As shown in FIG. 1, the light emitting elements 11R, 11G and 11B, respectively, include the anode 13, a common cathode 18 and the organic EL layers 15R, 15G and 15B, respectively. The EL layers are individually provided between each anode 13 and the common cathode 18.

Hereafter, in some cases, the light emitting elements 11R, 11G and 11B will be generically referred to as light emitting elements 11 and the organic EL layers 15R, 15G and 15B as organic EL layers 15.

The anode 13 is an electrode for injecting holes into each of the organic EL layers 15. A material for the anode 13 has, preferably, a large work function and an excellent conductivity.

Exemplary materials for the anode 13 include an oxide such as ITO (indium tin oxide), IZO (indium zinc oxide), In₃O₃, SnO₂, Sb-containing SnO₂ or Al-containing ZnO, Au, Pt, Ag, Cu, an alloy thereof or the like. One of them or a combination of two or more thereof may be used.

A mean thickness of the anode 13 is not specifically limited but preferably ranges approximately from 10 to 200 nm, and more preferably, approximately from 50 to 150 nm. If the anode 13 is too thin, it is unlikely to function sufficiently. Conversely, if it is too thick, light transmittance will significantly reduce depending on the kind of anode material or the like. Consequently, in the case of the light emitting elements 11R, 11G and 11B having the bottom emission structure, the elements will not be suitable for practical use.

Furthermore, as the anode material, a conductive resin material may be used, such as polythiophene or polypyrrole, for example.

Meanwhile, the cathode 18 is an electrode for injecting electrons into each of the organic EL layers 15.

A material for the cathode 18 has, preferably, a small work function. The material therefor may be Li, Mg, Ca, Sr, La, Ce, Er, Eu, Sc, Y, Yb, Ag, Cu, Al, Cs, Rb, Cr, Oy, Nd, an alloy thereof or the like. One thereof or a combination of two or more thereof (e.g. a multilayered structure having a plurality of layers) may be used.

Particularly, when an alloy is used as the material for the cathode 18, it is preferable to use an alloy containing a stable metal element such as Ag, Al or Cu, more specifically, an alloy such as MgAg, AlLi or CuLi. Using such an alloy can improve efficiency and stability in electron injection of the cathode 18.

A mean thickness of the cathode 18 is not specifically limited but preferably ranges approximately from 100 to 10,000 nm, and more preferably approximately from 200 to 500 nm. If the cathode 18 is too thin, it cannot function satisfactorily.

The light emitting elements 11 used in the present embodiment are the bottom emission type. Thus, light transmittance is not particularly required for the cathode 18.

Between the anode 13 and the cathode 18, each of the organic EL layers (light emitting layers) 15 is interposed so as to be in contact with both thereof.

When electricity is applied (voltage is applied) between the anode 13 and the cathode 18, a hole from the anode 13 and an electron from the cathode 18 are injected into each of the organic EL layers 15, where the hole and the electron are recombined, thereby resulting in light emission.

The method for manufacturing a light emitting device according to the embodiment is characterized by a process for individually forming the organic EL layers 15 (15R, 15G and 15B). Next described will be a structure of the organic EL layers 15 obtained by a method for manufacturing a semitransparent light emitting device, which will be described later.

In the embodiment, the organic EL layers 15 include a first organic EL layer 15R emitting light of red (first color), a second organic EL layer 15G emitting light of green (second color) and a third organic EL layer 15B emitting light of blue (third color), which are individually provided.

The first organic EL layer 15R is composed of a random copolymer. The random copolymer is generated by polymerization reaction between polymerizable groups included in a first light emitting compound and a first carrier transporting compound. The first light emitting compound includes a light emitting moiety having luminescent characteristics emitting red light and the polymerizable group having photopolymerization characteristics. The first carrier transporting compound includes a carrier transporting moiety having carrier transporting characteristics and the polymerizable group having photopolymerization characteristics.

The second organic EL layer 15G is composed of a random copolymer generated by polymerization reaction between polymerizable groups included in a second light emitting compound and a second carrier transporting compound. The second light emitting compound includes a light emitting moiety having luminescent characteristics emitting green light and the polymerizable group having photopolymerization characteristics. The second carrier transporting compound includes a carrier transporting moiety having carrier transporting characteristics and the polymerizable group having photopolymerization characteristics.

In addition, the third organic EL layer 15B is composed of a random copolymer generated by polymerization reaction between polymerizable groups included in a third light emitting compound and a third carrier transporting compound. The third light emitting compound includes a light emitting moiety having luminescent characteristics emitting blue light and the polymerizable group having photopolymerization characteristics. The third carrier transporting compound includes a carrier transporting moiety having carrier transporting characteristics and the polymerizable group having photopolymerization characteristics.

In other words, the organic EL layers 15R, 15G and 15B are each composed of a high polymer, in which the light emitting moiety having luminescent characteristics emitting each color light is combined with the carrier transporting moiety having carrier transporting characteristics in an arbitrary order via a linking structure formed by the polymerization of the polymerizable groups included therein.

Next, a description will be given as to the first to third light emitting compounds and the first to third carrier transporting compounds, sequentially.

The first to third light emitting compounds include the light emitting moieties having luminescent characteristics that emit lights of the first to third colors (red, green and blue) and the polymerizable groups having photopolymerization characteristics that link themselves to the light emitting moieties.

The light emitting moieties that emit lights of the first to third colors performs a function of emitting fluorescence and phosphorescence when holes and electrons injected in the organic EL layers 15 are recombined in the light emitting moieties.

Specifically, the holes and electrons injected in the organic EL layers 15 are supplied to the light emitting moieties to recombine with each other. Then, energy released upon the recombination thereof generates excitons. When the excitons return to a ground state, energy (fluorescence or phosphorescence) is released (light emission) by the light emitting moieties.

The light emitting moieties emitting the first to third color lights are not specifically limited. For example, those portions may each include a polymer having at least one of a carbazole skeleton, a fluorene skeleton and a paraphenylene vinylene skeleton, or a pigment such as perylene, rubrene, quinachridone, coumarin or Nile red, a metal complex such as an aluminum complex, an iridium complex, a beryllium complex or a zinc complex or the like. Among then, preferably, the light emitting moieties include a polymer having a carbazole skeleton or a fluorene skeleton, an aluminum complex or an iridium complex. This is because the light emitting moiety including any one thereof can exhibit especially excellent luminescent characteristics, as well as it can relatively easily introduce (link) polymerizable groups to be described below thereto.

Regarding the light emitting moieties emitting the first to third color lights, concrete examples including any one thereof mentioned above may include compounds expressed by Formulas 1-1 to 1-6 shown below.

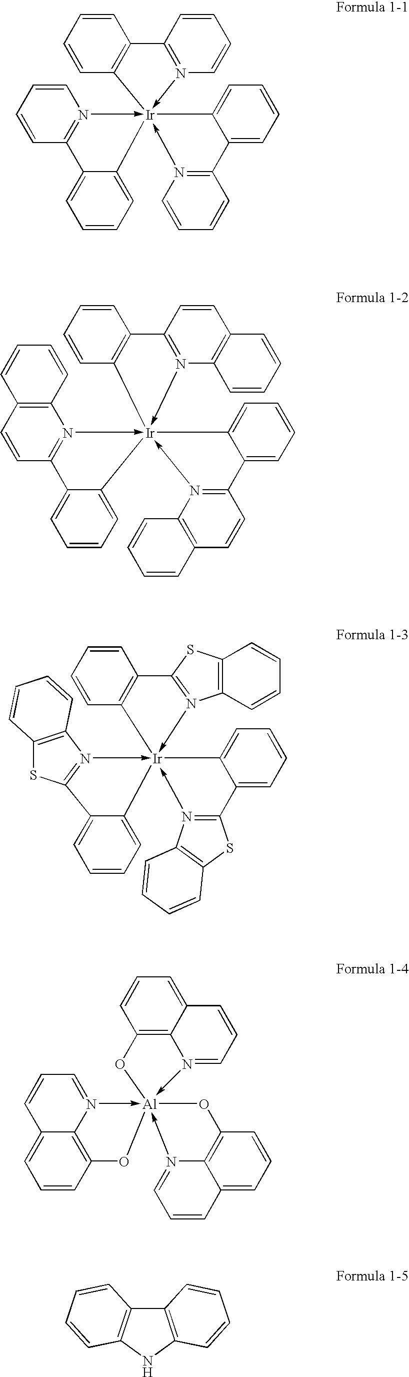

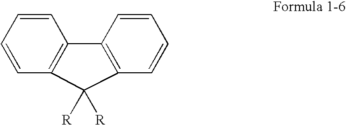

The two symbols R independently represent a hydrogen atom or an alkyl group.

Additionally, the above light emitting moieties may also have one or more substituents introduced thereto in order to control solubility into a light emitting compound solvent, colors of emitted light, etc. Those substituents are not specifically limited but may be, for example, a halogen atom such as a fluorine atom, a straight-chain alkyl group having 6 to 12 carbon atoms or the like.

Furthermore, when excitons go back to the ground state, the light emitting moiety including any one of the compounds expressed by Formulas 1- 1 to 1-3 above emit phosphorescence, whereas the light emitting moiety including any one of those expressed by Formulas 1-4 to 1-6 above emit fluorescence.

Among those including any one of the above compounds, the light emitting moiety that emits the first color (red) light include the compound expressed by Formula 1-2 or 1-3 shown above.

The light emitting moiety emitting the second color (green) light includes the compound expressed by Formula 1-1 or 1-4 shown above.

Furthermore, the light emitting moiety emitting the third color (blue) light includes one of compounds expressed by Formulas 1-7 and 1-8 shown below.

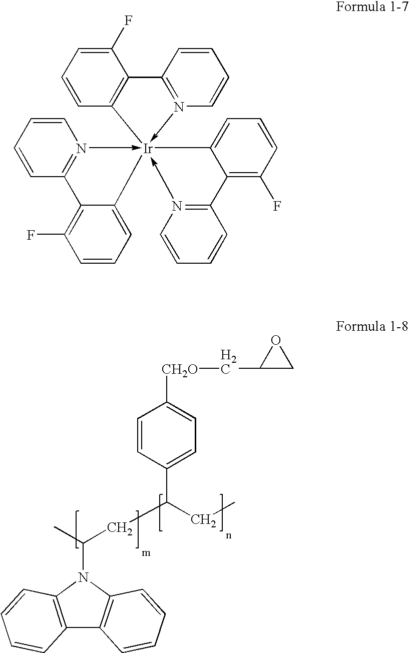

The polymerizable groups having photopolymerization characteristics included in the first to third light emitting compounds polymerize with those included in adjacent light emitting compounds or carrier transporting compounds to be described below. Thereby, the polymerizable groups serve to link the light emitting compounds (light emitting moieties) to each other or link the light emitting compounds to the carrier transporting compounds (carrier transporting moieties).

Such polymerizable groups are not specifically limited as long as they can undergo polymerization upon light irradiation in the method for manufacturing a light emitting device, which will be described below. Examples thereof may be substituents having a cyclic ether group such as an epoxy group or an oxetane group, an alkenyl group such as a (meta) acryloyl group, a vinyl ether group, a vinyl benzyl ether group, a vinyl group or an allyl group or the like at ends thereof. Appropriate kinds of the polymerizable groups will be selected in accordance with kinds of polymerization initiators to be described below.

Among such polymerizable groups, substituents having cyclic ether groups at the ends thereof exhibit radical polymerization characteristics. Those with alkenyl groups at the ends thereof exhibit cationic characteristics.

Additionally, the polymerizable groups may be either the same or different among the first to third light emitting compounds.

The first to third light emitting compounds each need at least one polymerizable group, but preferably, they each have a plurality of polymerizable groups introduced thereto. That is, preferably, the plurality of polymerizable groups is linked to the light emitting moiety. This arrangement can increase the number of light emitting compounds (light emitting moieties) linking to the light emitting compound and the number of carrier transporting compounds (carrier transporting moieties) linking thereto. This leads to maintaining (determining) a clearance between the light emitting moieties and a clearance between the light emitting moiety and the carrier transporting moiety at predetermined intervals. Consequently, carriers can more efficiently injected into the light emitting moieties. Furthermore, the random copolymer will have a shape that is neither linear nor straight-chained but a structure of molecules linked in a network, that is, a three-dimensional network structure. This can result in improvements in thermal resistance of the organic EL layers 15 and the injection efficiency of carriers into the light emitting moieties.

The plurality of polymerizable groups included in each of the first to third light emitting compounds may be mutually similar (or identical) or different among those shown above. However, preferably they are similar, particularly preferably identical. As a result, the polymerizable groups will exhibit homogeneous reactivities, which can ensure a randomization between the light emitting compound and the carrier transporting compound.

The organic EL layers 15R, 15G and 15B (random copolymers), respectively, may include a single kind of the first to third light emitting compounds, respectively. Alternatively, they may, respectively, include two or more kinds thereof that have light emitting moieties with different structures. Such compositions can be advantageous in that it is easier to control each light color of those EL layers.

Furthermore, the organic EL layers 15R, 15G and 15B may include compounds having luminescent characteristics which do not link to a random copolymer. Such compounds are not specifically limited, but, for example, may be the first to third light emitting compounds without any polymerizable groups. That is, those described above as the light emitting moieties may suitably be used.

The first to third carrier transporting compounds include the carrier transporting moieties having carrier transporting characteristics and the polymerizable groups linking thereto.

The carrier transporting moieties in each of the first to third carrier transporting compounds transport carriers (holes or electrons) injected from the electrode (the anode 13 or cathode 18) to the light emitting moiety in each of the first to third light emitting compounds.

As the carrier transporting moieties, there are a hole transporting portion for transporting holes injected from the anode 13 to the light emitting moiety and an electron transporting portion for transporting an electron injected from the cathode 18 thereto.

In other words, the first to third carrier transporting compounds each include a hole transporting compound with a hole transporting portion having hole transporting characteristics and an electron transporting compound with an electron transporting portion having electron transporting characteristics. Additionally, each of the organic EL layers 15R, 15G and 15B may include at least one of them, but preferably both of them. The composition can improve injection efficiencies of holes and electrons into the light emitting moieties, thereby further ensuring light emission from the light emitting moieties.

The hole transporting portion may include, for example, an arylamine skeleton, a dioxythiophene skeleton, a carbazole skeleton, a phthalocyanine skeleton or a porphyrin skeleton. Particularly, that with an arylamine skeleton is preferable. It is because such a hole transporting portion exhibits especially excellent hole transporting characteristics and can relatively easily introduce (link) polymerizable groups to be described below thereto.

Concrete examples of the hole transporting portion including an arylamine skeleton may be compounds expressed by Formulas 2-1 to 2-6 below, for example.

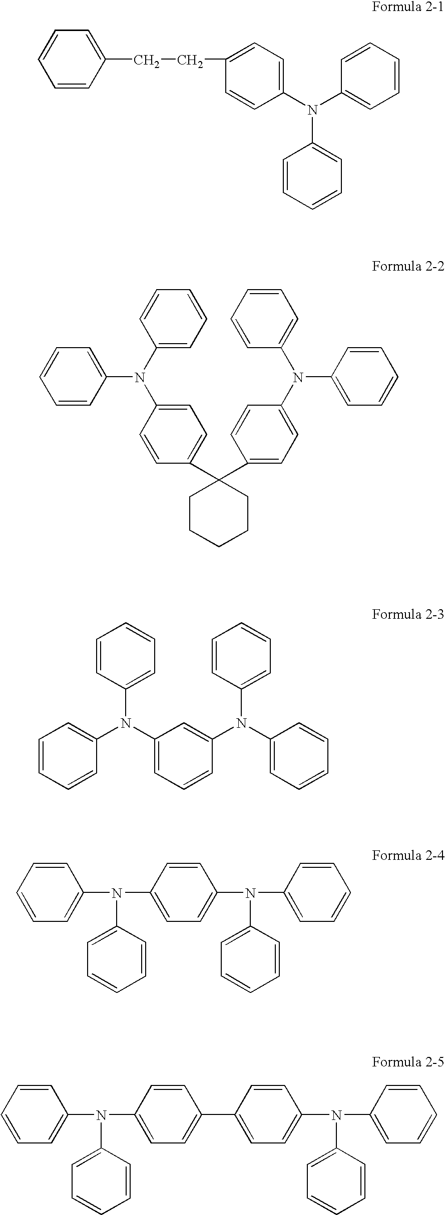

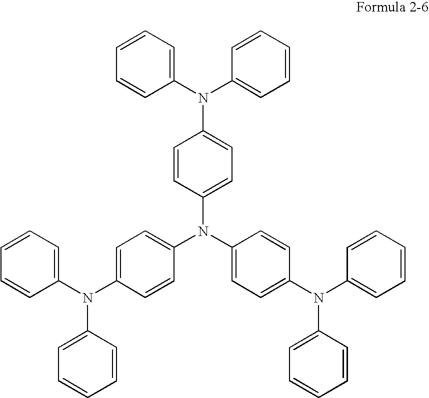

The hole transporting portions shown above may each have, for example, one or more substituents introduced thereto in order to control solubility of the hole transporting compound in a solvent, hole transporting characteristics thereof, etc. Such substituents are not specifically limited. Examples thereof may include a halogen atom such as a fluorine atom and a straight-chain alkyl group having 6 to 12 carbon atoms.

Meanwhile, the electron transporting portion may have, for example, an azole skeleton such as an oxadiazole skeleton, a thiadiazole skeleton or a triazole skeleton, a triazine skeleton or a pyridine skeleton. Among them, an oxadiazole or triazole skeleton is preferable. It is because the electron transporting portion including one of them can exhibit especially excellent electronic transporting characteristics and also can relatively easily introduce (link) polymerizable groups to be described below thereto.

Concrete examples of the electron transporting portion with an oxadiazole skeleton include compounds expressed by Formulas 3-1 to 3-4 below, for example.

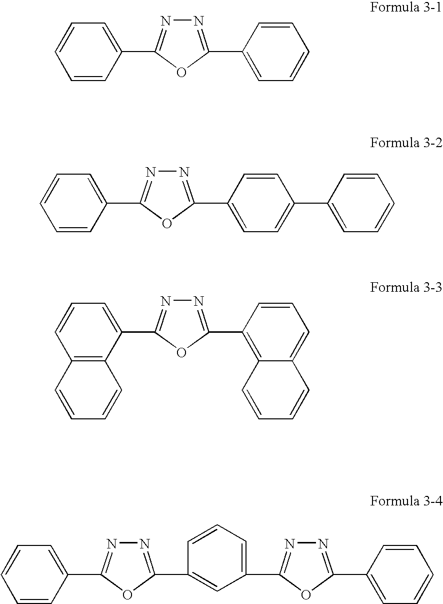

Concrete examples of the electron transporting portion with a triazole skeleton include compounds expressed by Formulas 4-1 and 4-2 below, for example.

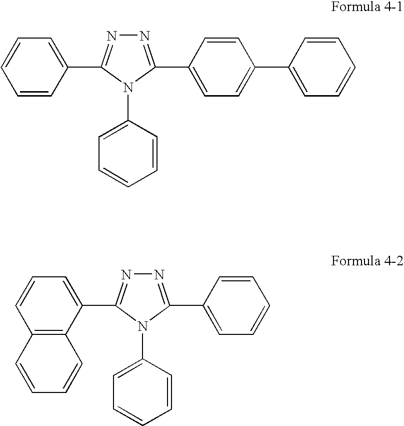

In addition, the electron transporting portions above may each have, for example, one or more substituents introduced therein in order to control solubility of the electron transporting compound in a solvent, electron transporting characteristics thereof, etc. Such a substituent is not specifically limited but may be, for example, a halogen atom such as a fluorine atom, a straight-chain alkyl group having 6 to 12 carbon atoms or the like.

Meanwhile, like those included in the first to third light emitting compounds described above, the polymerizable groups in the first to third carrier transporting compounds polymerize with those groups included in adjacent light emitting compounds or carrier transporting compounds to link the light emitting compounds (light emitting moieties) to the carrier transporting compounds (carrier transporting moieties) or mutually link the carrier transporting compounds.

The polymerizable groups included in the first to third carrier transporting compounds may be substituents similar to those in the above-described first to third light emitting compounds.

Such polymerizable groups may be identical or different among the first to third carrier transporting compounds.

In addition, at least one polymerizable group may be introduced to each of the first to third carrier transporting compounds, but preferably, a plurality thereof may be introduced thereto. That is, it is preferable to have the plurality of polymerizable groups linked to the carrier transporting compounds. The composition increases the numbers of the light emitting compounds and the carrier transporting compounds, both of which link to the carrier transporting compounds. This leads to maintaining (determining) a clearance between the light emitting moiety and the carrier transporting moiety and a clearance between the carrier transporting moieties at predetermined intervals. Consequently, carriers can more efficiently be injected from the carrier transporting moieties to the light emitting moieties. Furthermore, the random copolymer has a structure (shape) which is not linear but which is that of molecules linked in a network, that is, a three-dimensional network structure. This can improve thermal resistance of the organic EL layers 15 and the injection efficiency of carriers into the light emitting moieties from the carrier transporting moieties.

Additionally, when the first to third carrier transporting compounds each have the plurality of polymerizable groups therein, they may be similar (or identical) to or different from each other. However, preferably they are similar, particularly preferably identical. As a result, the polymerizable groups will exhibit homogeneous reactivities, which can ensure the randomization between the light emitting compounds and the carrier transporting compounds.

Furthermore, the polymerizable groups in the first to third light emitting compounds may be similar (or identical) to or different from those in the first to third carrier transporting compounds. However, preferably, both of them are mutually similar (particularly preferably identical). In this manner, homogeneous reactivities can be obtained between the polymerizable groups included in both the compounds. Therefore, the randomization between those compounds can be further ensured.

The organic EL layers 15R, 15G and 15B (random copolymers) may each include one of the hole transporting compounds shown above. Alternatively, they may include two or more thereof having hole transporting portions with different structures. Similarly, the organic EL layers 15 may each include one of the electron transporting compounds above, or alternatively, two or more thereof having electron transporting portions with different structures.

Furthermore, in addition to the above first to third light emitting compounds and carrier transporting compounds, a host compound may be included in each of the organic EL layers 15. The host compound has a host portion for supplying excitation energy to the light emitting moiety in each of the first to third light emitting compounds.

The host compound in the organic EL layers 15 allows at least some of holes and electrons to be injected (supplied) not into the light emitting moiety but into the host portion included therein. As a result, excitation energy moves from the host portion to the light emitting moiety (guest) in each of the first to third light emitting compounds.

Specifically, a hole injected from the anode 13 and an electron injected from the cathode 18 will be supplied into the host portion to recombine with each other. Upon the recombination thereof, energy will be released to generate excitons. The excitons release excitation energy when they return to the ground state. The excitation energy will be moved to the light emitting moieties as guests. Consequently, due to the excitation energy, excitons are generated. Those excitons emit fluorescence or phosphorescence upon return to the ground state. Thus, the above composition can reduce a loss in the energy generated upon the recombination of holes and electrons in the host portion. As a result, light emission efficiency in the light emitting moieties can be improved.

Examples of the host portion include various kinds of compounds. It is suitable to use a compound having a band gap of 3 eV or greater. For example, there may be mentioned compounds including polymers having at least any one of a carbazole skeleton, an arylamine skeleton, a fluorene skeleton and a phenanthroline skeleton. A particularly preferable compound may include a polymer having a carbazole or arylamine skeleton. This is because the host portion including one of them has an especially wide band gap.

Concrete examples of such a host portion may be compounds similar to those described above, for example.

The host portions above may have one or more substituents introduced thereinto. Such a substituent is not specifically limited but may be, for example, a halogen atom such as a fluorine atom, a straight-chain alkyl group having 6 to 12 carbon atoms or the like.

The host compounds included in the organic EL layers 15 are effective, particularly when the light emitting moieties in the light emitting compounds are those emitting phosphorescence, like compounds expressed by Formulas 1-1 to 1-3 above.

In addition, the host compounds included in the organic EL layers 15 may be unlinked to the random copolymers obtained by polymerization between the light emitting compounds and the carrier transporting compounds. Preferable host compounds may be those included as random copolymers obtained by polymerization among the light emitting compounds, the carrier transporting compounds and the host compounds.

Therefore, preferably, the host compounds include polymerizable groups linking to the host portions. In this manner, the random copolymer can be obtained (generate) by polymerization among the polymerizable groups included in the light emitting compounds, the carrier transporting compounds and the host compounds.

The polymerizable groups in the host compounds may be substituents similar to those included in the light emitting compounds described above.

The host compounds may each have at least one polymerizable group introduced therein. However, preferably, a plurality of polymerizable groups may be introduced thereinto. In other words, it is preferable to have the plurality of polymerizable groups linked to each of the host portions. This can increase the numbers of the light emitting compounds (light emitting moieties), the carrier transporting compounds (carrier transporting moieties) and the host compounds (host portions), which all link to the host compounds. As a result, clearances among the light emitting moieties, the carrier transporting moieties and the host portions will be maintained (determined) at predetermined intervals. Consequently, carriers can be more efficiently injected from the carrier transporting moieties to the host portions, as well as excitation energy can more efficiently be moved from the host portions to the light emitting moieties. Moreover, the random copolymer will have a structure (shape) which is not linear but which is that of molecules linked in a network, that is, a three-dimensional network structure. The structure can improve the thermal resistance of the organic EL layers 15, the injection efficiency of carriers from the carrier transporting moieties into the host portions and the moving efficiency of the excitation energy from the host portions to the light emitting moieties.

Additionally, in the host compound including the plurality of polymerizable groups, those polymerizable groups may be mutually similar (or identical) to or different. However, preferably, they are mutually similar (particularly preferably identical). This allows the polymerizable groups to exhibit homogeneous reactivities, thereby ensuring the randomization among the light emitting compound, the carrier transporting compound and the host compound.

Furthermore, the polymerizable groups may be similar (or identical) or different among the above compounds. However, preferably they are similar (particularly preferably identical) among them. This can result in homogeneous reactivities among the polymerizable groups, thereby ensuring the randomization among the compounds.

A mean molecular weight per the random copolymer above is not specifically limited. Preferably, it ranges approximately from 10,000 to 1000,000, more preferably approximately from 15,000 to 300,000. In this manner, random copolymers become entangled with each other at high densities in the organic EL layers 15. Such entanglement allows smooth transportation of carriers from the carrier transporting moieties to the light emitting moieties.

In the organic EL layers 15, the light emitting compounds and the carrier transporting compounds may be composed of low molecules (monomers or oligomers) to an extent where the light emitting moieties can exhibit excellent luminescent characteristics.

A mean thickness of the organic EL layers 15 is not specifically limited, but preferably it ranges approximately from 10 to 300 nm, more preferably approximately from 50 to 150 nm.

The above random copolymer is configured to have a light emitting moiety and carrier transporting moieties (hole and electron transporting portions) in a single molecule (high molecule). Accordingly, only a single layer is needed to provide each organic EL layer 15 which can serve as both the light emitting layer and the carrier transporting layer.

The light emitting apparatus 110 having the structure as described above includes a sealing member (not shown). The sealing member is provided so as to entirely cover the light emitting elements 11 to seal them airtightly.

The sealing member serves to inhibit the entry of oxygen and moisture from outside air. Accordingly, the sealing member can prevent degeneration and deterioration of each portion (each layer) included in the light emitting elements 11. Therefore, it can improve reliability and endurance in the light emitting elements 11.

The sealing member may be made of, for example, any one of glass materials, Al, Au, Cr, Nb, Ta, Ti or alloys thereof, oxidized silicon, various resin materials, etc.

Additionally, the sealing member may be a flat plate disposed opposite to the TFT circuit substrate 20, and a region between the plate and the substrate 20 may be sealed with a sealer containing a thermosetting resin or the like, for example.

Method for Manufacturing a Light Emitting Device

The above light emitting device 110 can be obtained by the method for manufacturing a light emitting device according to the embodiment. One example of the method will be described below.

Hereinafter, described will be a method for manufacturing the light emitting device 110 (the manufacturing method according to the embodiment).

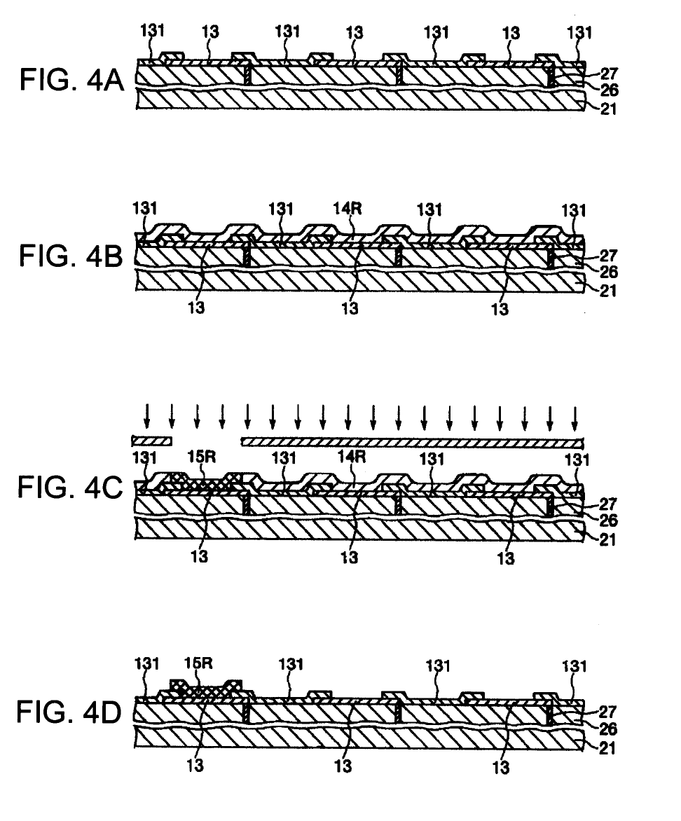

FIGS. 4A to 5E are longitudinal sectional views of the active-matrix light emitting device obtained by applying the method according to the embodiment. In the description below, upper and lower sides in each of the drawings will be regarded as “upper” and “lower”, respectively.

1. First, the substrate 21 is prepared and the underlying protective layer 23 is formed thereon. The underlying protective layer 23 is formed, for example, by a plasma chemical vapor deposition (CVD) process or the like, using a tetra-ethoxy-silane (TEOS) gas, an oxygen gas or the like as a raw material gas. The underlying protective layer 23 is composed mainly of oxidized silicon having a mean thickness of approximately 200 to 500 nm.

2. Next, each driving TFT 24 is formed on the underlying protective layer 23.

First, in a state where the substrate 21 is heated at approximately 350 degrees centigrade, a semiconductor film is formed on the underlying protective layer 23 by the plasma CVD process or the like, for example. The semiconductor film is composed mainly of amorphous silicon having a mean thickness of approximately 30 to 70 nm.

Then, the semiconductor film is crystallized using laser annealing, a solid phase growth process or the like to change the amorphous silicon into polysilicon.

In this case, an example of the laser annealing may be an excimer laser using a beam line having a lengthwise length of 400 mm, where an output intensity level thereof is approximately 200 mJ/cm², for example. Additionally, regarding the line beam, scanning is performed with an overlapping ratio equivalent to 90% of peak laser intensity in a crosswise direction of the beam in each region.

Next, the semiconductor film is patterned into an island shape. Then, each gate insulating layer 242 is formed, for example, by the plasma CVD process or the like using a tetra-ethoxy-silane (TEOS) gas, an oxygen gas or the like as a raw material gas so as to cover each island-shaped semiconductor layer 241. The gate insulating layer 242 is made mostly of silicon oxide, silicon nitride or the like and has a mean thickness ranging approximately from 60 to 150 nm.

Next, a conductive film is formed on the gate insulating layer 242 by sputtering or the like, for example. The conductive film is made mostly of a metallic material such as aluminum, tantalum, molybdenum, titanium or tungsten. After that, the conductive film is patterned to form each gate electrode 243.

Subsequently, in this situation, a high-dose phosphorus ion implantation is performed to form a source-drain region in a self-aligning manner with respect to the gate electrode 243. A part where no impurity is introduced becomes a channel region.

3. Next, each source electrode 244 and each drain electrode 245 are formed to be electrically connected to the driving TFT 24.

First, the first interlayer insulating layer 25 is formed so as to cover the gate electrode 243 and then contact holes are formed.

Next, the source electrode 244 and the drain electrode 245, respectively, are formed in the contact holes, respectively.

4. Then, each wire (relay electrode) 27 is formed to electrically connect the drain electrode 245 to each anode 13.

First, after forming the second interlayer insulating layer 26 on the first interlayer insulating layer 25, contact holes are formed.

Next, the wire 27 is formed in each contact hole.

5. Sequentially, each anode (pixel electrode) 13 is formed on the second interlayer insulating layer 26 so as to contact with the wire 27.

The anode 13 can be formed in the same manner as the gate electrode 243.

6. Next, as shown in FIG. 4A, each partition (bank) 131 is formed on the second interlayer insulating layer 26 so as to partition each of the anodes 13.

Specifically, the partition 131 is provided such that the anode 13 is exposed out at an opening thereof formed. At the opening thereof, each organic EL layer 15, which will be provided by the following process 7, contacts with the anode 13. As a result, the opening becomes a luminescent region where the organic EL layer 15 emits light.

The partition 131 may be provided by patterning or the like, using photolithography or the like, after forming an insulating film so as to cover the anode 3 and the second interlayer insulation film 26.

A material used for the partition 131 is selected in consideration of thermotolerance, lyophobic characteristics, ink-solvent resistance, adhesiveness to the underlying layer, etc.

Specifically, examples of the material therefor may include inorganic materials such as SiO₂ and organic materials such as an acrylic resin, a polyimide resin and a fluorocarbon resin.

Furthermore, in FIG. 2, the opening of the partition 131 has a square (quadrilateral) shape. However, the shape thereof may be, for example, circular, oval or polygonal such as hexagonal, and is not specifically limited.

In addition, the formation of the partition 131 may be omitted depending on the shape of the anode 13.

7. Next, on the anode 13 configured shown in FIG. 4A is formed each of the organic EL layers 15R, 15G and 15B, as shown in FIG. 5D. The EL layers 15R, 15G and 15B, respectively, emit red (first color) light, green (second color) light and blue (third color) light, respectively.

The manufacturing method according to the embodiment is characterized by a method for manufacturing the organic EL layers 15R, 15G and 15B.

In the related art shown above, the bank with an opening is formed on a substrate and a liquid material containing light emitting agent is supplied into the opening by an inkjet method, so that each organic EL layer is formed. The method limits options for a light emitting material and a solvent to be used for preparation of the liquid material.

Thus, the inventors of the present invention closely examined a method for forming an organic EL layer (light emitting layer) into a desired shape without providing a bank on a substrate. Then, it was resulted that the following method allows organic EL layers to be formed into a desired shape. The invention has been completed based on the results.

Specifically, the manufacturing process was performed as follows: 1. First, a coated film was formed on a substrate. The coated film includes a monomer (light emitting compound) having luminescent characteristics and a monomer (carrier transporting compound) having carrier transporting characteristics; 2. Next, light was irradiated on a predetermined region of the coated film to cause random polymerization between the monomer with the luminescent characteristics and the monomer with the carrier transporting characteristics existing in the coated film. In other words, there was obtained a random copolymer including the light emitting compound and the carrier transporting compound in a region where the light was incident on the coated film; 3. Then, after removing a non-irradiated region on the coated film, that is, a region having no random copolymer formed thereon, each layer made of the random copolymer was formed in only the light-irradiated region. When a voltage is applied to each of the random copolymer layers, the light emitting compound is linked to the carrier transporting compound within a single molecule, so that layer (organic EL layer) can exhibit excellent luminescent characteristics. Consequently, the inventors found out the excellent features, thereby resulting in the invention.

Hereinafter, a detailed description will be given of the method for forming the organic EL layers 15R, 15G and 15B.

7-1: First, as shown in FIG. 4B, on the anodes (first electrode) 13 and the partitions 131, there is formed a first coated film 14R that includes a first light emitting compound and a first carrier transporting compound (First process). The first light emitting compound includes the light emitting moiety having luminescent characteristics emitting red (first color) light and a polymerizable group having photopolymerization characteristics. The first carrier transporting compound includes the carrier transporting moiety having carrier transporting characteristics and a polymerizable group having photopolymerization characteristics.

The first coated film 14R can be provided by any one of various processing methods such as a liquid or gas phase process, but preferably is formed by a liquid phase process.

The liquid phase process does not require any large equipment such as a vacuum device used in a gas phase process. Through the simple process, a first liquid material containing the first light emitting compound and the first carrier transporting compound can relatively easily be supplied on the anodes 13 and the partitions 131. Thus, it is a preferably applicable method.

An example will be described below as to the formation of the first coated film on the anodes 13 and the partitions 131 through the liquid phase process.

First, the first liquid material including the first light emitting compound and the first carrier transporting compound is supplied on the anodes 13 and the partitions 131 by a coating material applying method or the like to form the first coated film 14R.

Depending on kinds of the first light emitting compound (light emitting moiety) and the first carrier transporting compound (carrier transporting moiety) to be used, a ratio between those compounds in the first coated film 14R greatly varies. A preferable weight ratio therebetween ranges from 1:100 to 90:10. The ratio set within the above range can ensure that carriers injected from the electrodes are supplied to the light emitting moiety via the carrier transporting moiety in the formed organic EL layer 15R. This can improve the efficiency of carrier injection into the light emitting moiety.

Examples of the above coating material applying method include spin-coating, casting, microgravure coating, gravure coating, bar coating, roll coating, wire bar coating, dip coating, spray coating, screen printing, flexo printing, offset printing and inkjet printing. Among them, spin coating is preferable. The method allows the first liquid material to have a relatively wide range of viscosity and surface tension. Accordingly, it is advantageous in that wider options will be available for those first compounds and solvents included in the first liquid material.

Furthermore, it is almost unnecessary to add modifiers for modifying the viscosity and surface tension of the first liquid material. Accordingly, in the organic EL layer 15 formed through the following process 7-2, the random copolymer will never be degenerated or deteriorated by such modifiers.

Examples of the solvent used for preparing the first liquid material include inorganic solvents made of nitrate, sulfate, ammonia, hydrogen peroxide, water, carbon disulfide, carbon tetrachloride, ethylene carbonate and the like, as well as various kinds of organic solvents, such as ketone solvents made of methyl ketone (MEK), acetone, diethyl ketone, methyl isobutyl ketone (MIBK), methyl isopropyl ketone (MIPK), cyclohexanone and the like, alcoholic solvents made of methanol, ethanol, isopropanol, ethylene glycol, diethylene glycol (DEG), glycerin and the like, ether solvents made of diethylene ether, diisopropyl ether, 1,2-dimethoxyethane (DME), 1,4-dioxane, tetrahydrofuran (THF), tetrahydropyran (THP), anisole, diethylene glycol dimethyl ether (diglyme), diethylene glycol ethyl ether (carbitol) and the like, cellosolve solvents made of methyl cellosolve, ethyl cellosolve, phenyl cellosolve and the like, aliphatic hydrocarbons solvents made of hexane, pentane, heptane, cyclohexane and the like, aromatic hydrocarbon solvents made of toluene, xylene, benzene and the like, aromatic heterocyclic compound solvents made of pyridine, pyrazine, furan, pyrrole, thiophene, methyl pyrrolidone and the like, amide solvents made of N,N-dimethylformamide (DMF), N,N-dimethylacetoamide (DMA) and the like, halogen compound solvents made of chlorobenzene, dichloromethane, chloroform, 1,2-dichloroethane and the like, ester solvents made of ethyl acetate, methyl acetate, ethyl formate and the like, sulfur compound solvents made of dimethyl sulfoxide (DMSO), sulfolane and the like, nitrile solvents made of acetonitrile, propionitrile, acrylonitrile and the like, organic acid solvents made of formic acid, acetate, trichloroacetic acid, trifluoroacetic acid, mixed solvents containing those above and the like.

Additionally, preferably, the first liquid material includes a polymerization initiator. The initiator can promote polymerization between the first light emitting compound and the first carrier transporting compound in the first coated film when light is irradiated on the film, in the following process 7-2.

The polymerization initiator is not specifically limited but may be a photo-cationic polymerization initiator, a photo-radical polymerization initiator or the like, for example.

The polymerizable groups included in the first light emitting compound and the first carrier transporting compound are preferably similar (particularly preferably identical) to each other, as described above. Preferable examples of the polymerizable groups include those having a (meta) acryloyl group, a vinyl benzyl ether group, an allyl group or the like at ends thereof, that is, those having radical polymerization characteristics. When selecting such a polymerizable group, a photo-radical polymerization initiator is particularly preferable.

The photo-radical polymerization initiator may be selected from various kinds of those such as benzophenone, benzoin, acetophenone, benzylketal, Michler's ketone, acylphosphine oxide, ketocoumarin, xanthene and thioxanthone.

Furthermore, when the above-described polymerizable groups are, for example, those having an epoxy group, an oxetane group or a vinyl ether group at ends thereof, that is, when they are the polymerizable groups having cationic polymerization characteristics, it is particularly preferable to use a photo-cationic polymerization initiator as a polymerization initiator for them.

The photo-cationic polymerization initiator may be selected from various kinds of those. For example, there may be mentioned onium salts such as aromatic sulfonium salt, aromatic iodonium salt, aromatic diazonium salt, pyridium salt and aromatic phosphonium salt, or nonionic compounds such as an iron arene complex and a sulfonate ester.

When the polymerization initiator is appropriately selected in accordance with the kinds of polymerizable groups to be used, it can relatively easily promote the polymerization reaction between the first light emitting compound and the carrier transporting compound in the following process 7-2.

Additionally, the first liquid material may also include a sensitizer suitable to a photopolymerization initiator.

7-2. Next, as shown in FIG. 4C, for example, through a mask having an opening positioned in a region for forming the organic EL layer 15R, light is irradiated on the first coated film 14R. As a result, the first light emitting compound polymerizes with the first carrier transporting compound in the coated film. Then, a light-irradiated region on the film is hardened, whereby the organic EL layer (first light emitting layer) 15R is produced (Second process).

The light irradiated on the first coated film 14R may be, for example, infrared light, visible light, ultraviolet (UV) light, X ray or the like. One of them or a combination of two or more thereof may be used. Among them, UV light is particularly preferable. It can easily and reliably promote the polymerization reaction between the first two compounds.

A wavelength of UV light to be irradiated preferably ranges approximately from 100 to 420 nm, more preferably approximately from 150 to 400 nm.

In addition, an irradiation intensity of the UV light preferably ranges approximately from 1 to 600 mW/cm², more preferably approximately from 1 to 300 mW/cm².

An irradiation time of the UV light preferably ranges approximately from 10 to 900 seconds, more preferably, approximately 10 to 600 seconds.

With the wavelength, irradiation intensity and time of the UV light set in the above ranges, it is easier to control progress of the polymerization between the two compounds in the first coated film 14R.

7-3. Next, as shown in FIG. 4D, there is removed a region other than the light-irradiated region on the first coated film 14R, that is, a region other than the region where the organic EL layer 15R has been formed (Third process).

The method for removing the first coated film 14R is not specifically limited. For example, there may be suitably used a method for dissolving the first coated film 14R by supplying a solvent used to prepare the first liquid material.

The above method can ensure the removal of the first coated film 14R, thereby reliably preventing the organic EL layer 15R composed of a copolymer (macromolecule) from dissolving in a solvent.

7-4. Next, as shown in FIG. 5A, on the anodes (first anodes) 13, the partitions 131 and the organic EL layers 15R, there is formed a second coated film 14G that includes the second light emitting compound and the second carrier transporting compound (Fourth process). The second light emitting compound includes the light emitting moiety having luminescent characteristics emitting green (second color) light and the polymerizable group having photopolymerization characteristics. The second carrier transporting compound includes the carrier transporting moiety having carrier transporting characteristics and the polymerizable group having photopolymerization characteristics.

The method for forming the second coated film 14G may be the same as that for forming the first coated film 14R in the previous process 7-1.

A ratio between the second light emitting compound and the second carrier transporting compound in the second coated film 14G greatly varies depending on kinds of the compounds to be used. A preferable weight ratio between them ranges from 1:100 to 90:10. The ratio set within the above range can ensure that carriers injected from the electrodes are supplied to the light emitting moiety via the carrier transporting moiety in the formed organic EL layer 15G. This can improve the efficiency of carrier injection into the light emitting moiety.

In this case, since the organic EL layer 15R is composed of a macromolecule (random copolymer), it shows enhanced durability and solvent resistance. Thus, as shown in FIG. 5A, even in the case of forming the second coated film 14G on the organic EL layer 15R, a solvent in a second liquid material used for forming the second coated film 14G can appropriately inhibit or prevent the swelling or dissolution of the random copolymer included in the organic EL layer 15R. As a result, mutual dissolution between the organic EL layer 15R and the second coated film 14G can be reliably prevented.

7-5. Next, as shown in FIG. 5B, for example, through a mask having an opening positioned in a region where the organic EL layer 15G is formed, light is irradiated on the second coated film 14G. As a result, the second light emitting compound polymerizes with the second carrier transporting compound in the second coated film 14G. Then, a light-irradiated region on the film is hardened, whereby the organic EL layer (second light emitting layer) 15G is produced (Fifth process).

The light irradiated on the second coated film 14G may be the same as that explained as the light irradiated on the first coated film 14R in the previous process 7-2.

7-6. Next, as shown in FIG. 5C, there is removed a region other than the light-irradiated region on the second coated film 14G, that is, a region other than the region where the organic EL layers 15G has been formed (Sixth process).

The method for removing the second coated film 14G may be the same as that for removing the first coated film 14R in the previous process 7-3.

7-7. Next, on the anodes (first anodes) 13, the partitions 131 and the organic EL layers 15R and 15G, there is formed a third coated film 14B including a third light emitting compound and a third carrier transporting compound. The third light emitting compound includes the light emitting moiety having luminescent characteristics emitting blue (third color) light and the polymerizable group having photopolymerization characteristics. The third carrier transporting compound includes the carrier transporting moiety having carrier transporting characteristics and the polymerizable group having photopolymerization characteristics.

The method for forming the third coated film 14B may be the same as that for forming the first coated film 14R in the previous process 7-1.

A ratio between the third light emitting compound and the third carrier transporting compound in the third coated film 14B greatly varies depending on kinds of the compounds to be used. A preferable weight ratio between them ranges from 1:100 to 90:10. The ratio therebetween set within the above range can ensure that carriers injected from the electrodes are supplied to the light emitting moiety via the carrier transporting moiety in the formed organic EL layer 15B. This can improve the efficiency of carrier injection into the light emitting moiety.

7-8. Next, for example, through a mask having an opening positioned in a region where the organic EL layer 15B is formed, light is irradiated on the third coated film 14B. The irradiation allows polymerization between the third light emitting compound and the third carrier transporting compound in the third coated film 14B. As a result, a light-irradiated region on the film 14B is hardened and whereby the organic EL layer 15B is produced.

The light irradiated on the third coated film 14B may be the same as that explained as the light irradiated on the first coated film 14R in the previous process 7-2.

7-9. Next, there is removed a region other than the light-irradiated region on the third coated film 14B, that is, a region other than the region where the organic EL layer 15B has been formed.

A method for removing the third coated film 14B may be the same as that for removing the first coated film 14R explained in the previous process 7-3.

Through all the above processes, on the anodes 13 are provided the organic EL layers 15R, 15G and 15B, as shown in FIG. 5D.

8. Next, a cathode 18 is formed so as to cover those organic EL layers 15 and the partitions 131.

That is, the cathode 18 (second electrode) is formed on a side opposite to the anodes 13 of the organic EL layers 15 (Seventh process).

The cathode 18 can be formed using a gas phase deposition method such as vacuum evaporation or sputtering, a liquid phase deposition method using fine-grained metal ink, bonding of a conductive sheet member (metal foil) or the like.

9. Next, each light emitting element 11 is covered with a box-shaped sealing member and bonded to the TFT circuit substrate 20 with a curing resin (adhesive agent). In this manner, each light emitting element 11 is sealed with the sealing member to complete the light emitting device 110.

The curing resin to be used may be a thermosetting resin, a photosensitive resin, a reactive curing resin or an anaerobic curing resin.

Through all the processes above, manufacturing of the light emitting device 110 is completed.

In the manufacturing method above, without forming a bank on the second interlayer insulating layer 26, each of the organic EL layers 15 can be formed into a desired shape.

In addition, since the organic EL layers 15 are composed of the random copolymer (macromolecule), it can reliably be prevented that the composite material of the organic EL layers 15 flows out to the outside thereof over time. Therefore, degeneration and deterioration of those EL layers can suitably be prevented or suppressed.

Furthermore, in the formation of the organic EL layers 15 and the formation of the cathode by using fine-grained metal ink, there is no need for large-scale equipment such as a vacuum device. This can reduce the time and cost for manufacturing the light emitting elements 11 (light emitting device 110).

Furthermore, the random copolymer in each of the organic EL layers 15 performs both functions of light emission and carrier transportation. Thus, the organic EL layers 15 each can be configured as a single layer serving as both a light emitting layer and a carrier transporting layer. This can reduce the number of processes for manufacturing the light emitting elements 11, thereby resulting in improvement in productivity of the elements.

A system for driving the light emitting device is not limited to the active-matrix system explained in the present embodiment and may be a passive matrix system, for example. Electronic Apparatus

Next, a description will be given of an electronic apparatus including the above light emitting device.

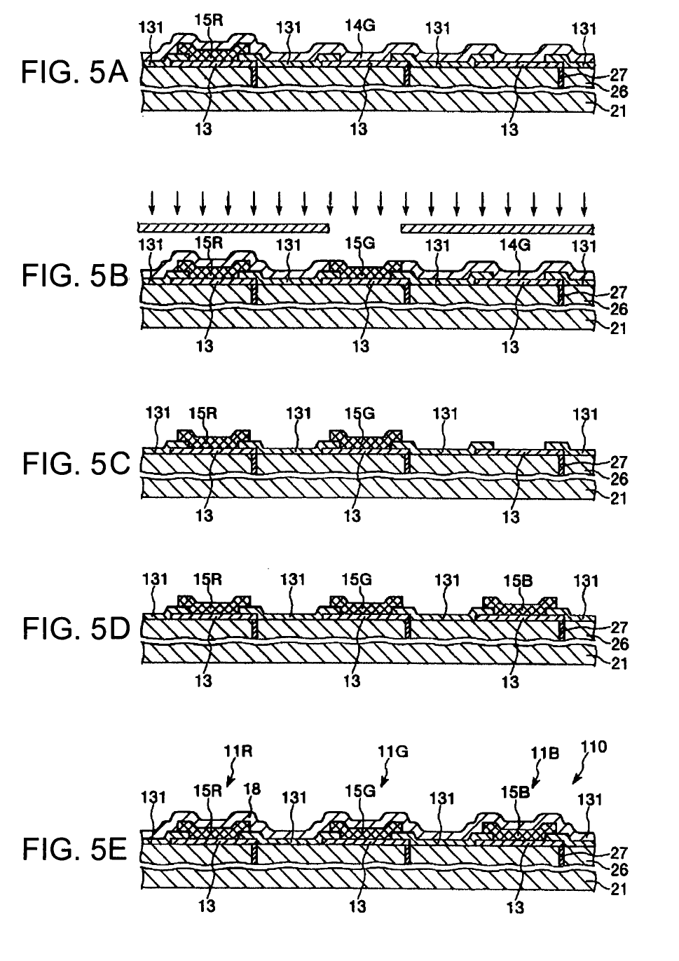

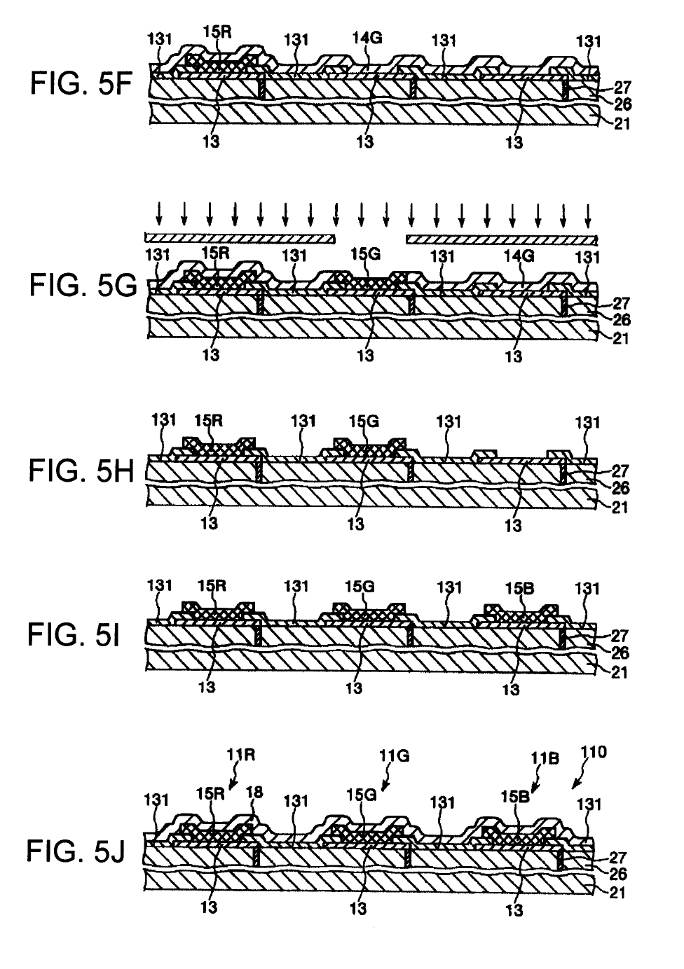

FIG. 6 is a perspective view showing a structure of a mobile (notebook) personal computer including the light emitting device.

In the drawing, a personal computer 1100 includes a main body 1104 having a keyboard 1102 and a display unit 1106 having a display section. The display unit 1106 is supported rotatably via a hinge structure with respect to the main body 1104.

In the personal computer 1100, the display section of the display unit 1106 is constituted by the above-described light emitting device 110.

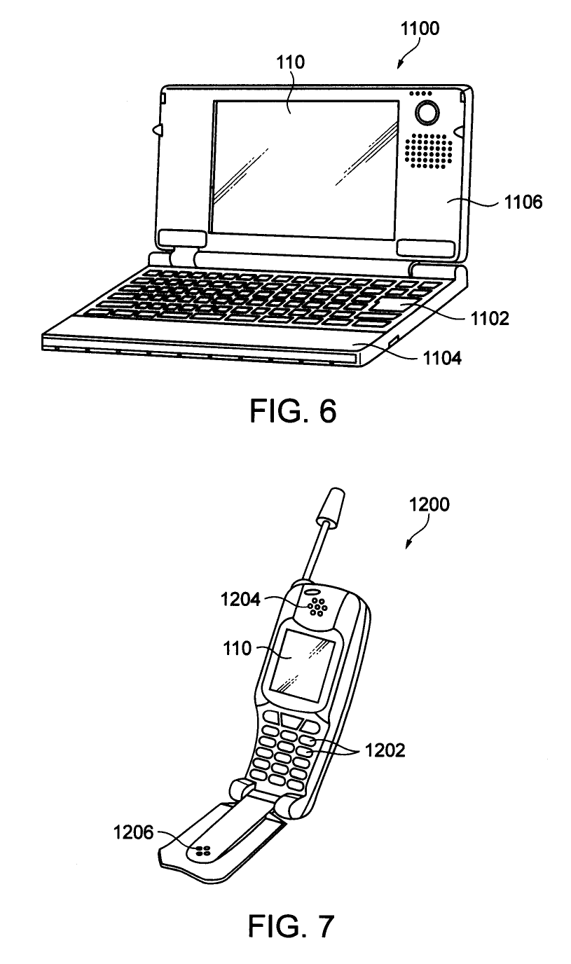

FIG. 7 is a perspective view showing a structure of a mobile phone (including PHS) including the light emitting device 110.

In the drawing, a mobile phone 1200 has a plurality of touch buttons 1202, a speaker aperture 1204 and a microphone aperture 1206, with a display section.

In the mobile phone 1200, the display section is constituted by the light emitting device 110 described above.

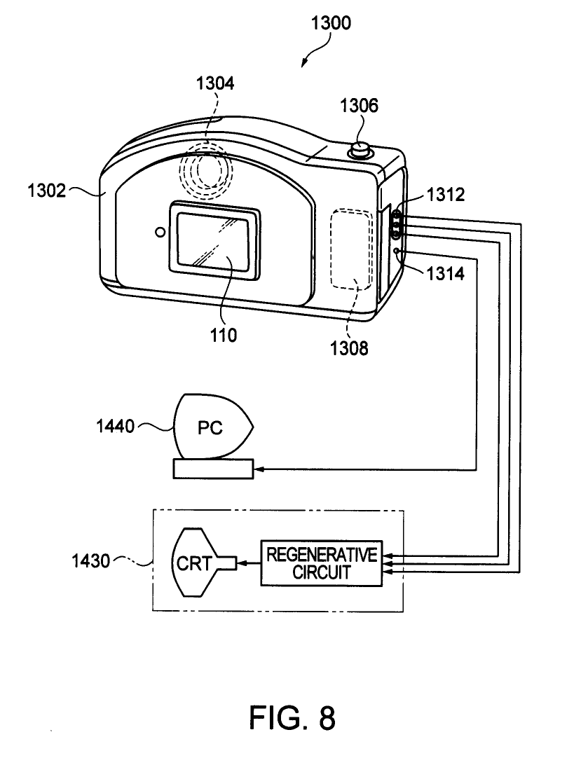

FIG. 8 is a perspective view showing a structure of a digital still camera including the light emitting device 110. The drawing also shows connections with external apparatuses simply.

In an ordinary camera, a silver halide film is exposed to light of an optical image of an object, whereas a digital still camera 1300 generates an image-signal (image signal) by photoelectric conversion of the optical image of an object using an image-pickup element such as a charge coupled device (CCD).

On a rear surface of a casing (body) 1302 in the digital still camera 1300, a display section is disposed to display images based on image-pickup signals from the CCD. Thus, the display section serves as a finder to display an electronic image of the object.

In the digital still camera 1300, the display section is constituted by the above-described light emitting device 110.

The casing has a circuit substrate 1308 disposed therein. The circuit substrate 1308 is provided with a memory capable of storing (memorizing) image-pickup signals.

In addition, on a front surface (a back surface in the structure shown in the drawing) of the casing 1302 is provided a light-receiving unit 1304 including an optical lens (imaging optical system), CCD, etc.

When a photo-taker confirms the image of an object displayed on the display section and then pushes down a shutter button 1306, an image signal of the CCD at the point in time is transferred to the memory of the circuit substrate 1308 to be stored therein.

In the digital still camera 1300, a video signal output terminal 1312 and an input-output terminal 1314 used for data communications are disposed on a side surface of the casing 1302. Then, as shown in the drawing, the video signal output terminal 1312 will be connected to a television monitor 1430, and the input-output terminal 1314 for data communications will be connected to a personal computer 1440 as needed, respectively. Furthermore, with a predetermined operation, the image-pickup signal stored in the memory of the circuit substrate 1308 is supposed to be output to the television monitor 1430 or the personal computer 1440.

In addition to the personal computer (mobile personal computer) in FIG. 6, the mobile phone in FIG. 7 and the digital still camera in FIG. 8, various kinds of equipments can employ the electronic apparatus according to the embodiment. Examples of applications thereof include a television set, a video camera, a view-finder type or monitor direct-view-type video tape recorder, a laptop personal computer, a car navigation device, a pager, an electronic organizer (with communications functions), an electronic dictionary, an electronic calculator, an electronic game device, a word processor, a work station, a video phone, a security television monitor, an electronic binocular, a POS terminal, a device equipped with a touch panel (e.g. a cash dispenser in banking facilities, an automatic ticket vending machine), a medical device (e.g. an electronic thermometer, an electronic manometer, a glucosemeter, an electrocardiographic equipment, an ultrasonic diagnostic equipment, an endoscopic display), a fish detector, measuring equipments, gauging instruments (e.g. instruments of cars, airplanes and ships), a flight simulator, other kinds of monitors, a projection display apparatus such as a projector, etc.

In order to manufacture the electronic apparatus having the structure described above, it is only necessary to include the method for manufacturing the light emitting device as described above.

According to the embodiment of the invention, the description above has been made about the methods for manufacturing a light emitting element, a light emitting device and an electronic apparatus with reference to the drawings. However, the invention is not limited to the embodiment.

### EXAMPLES

Hereinafter, concrete examples will be shown to further illustrate the method according to the embodiment.

1. Synthesis of Compounds

First, syntheses of compounds were performed as follows.

Synthesis of a polymerizable iridium complex A1 expressed by Formula 5-1 shown below:

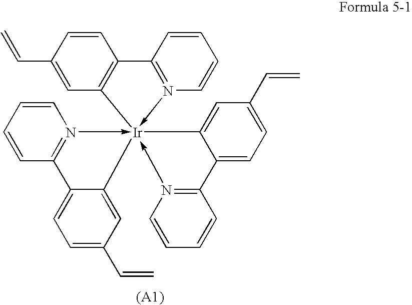

The polymerizable iridium complex A1 is a compound emitting green light.

First, through a synthetic route represented by formula 5-2 shown below, 2-(4-vinylphenyl)pyridine A11 was synthesized.

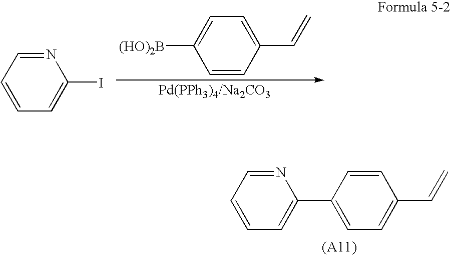

Now, tetrakis(triphenylphosphine)palladium (0) (1 mmol) and 4-vinylphenylboronic acid (10 mmol: manufactured by Tokyo Chemical Industry Co., Ltd.) were added into an xylene solution containing 2-iodopyridine (10 mmol) and stirred.

Next, under a nitrogen atmosphere, a sodium hydrogen carbonate solution was added into the above mixed solution and heated to reflux for 12 hours.

Then, a methylene chloride/water mixture was added to the above reaction mixture and an aqueous layer was extracted with methylene chloride.

Next, an organic layer obtained was dried with anhydrous magnesium sulfate and the solvent was condensed under reduced pressure. Finally, a resulting solid precipitate was recrystallized from xylene to obtain 2-(4-vinylphenyl)pyridine All (yield: 65%).

Now, through a synthetic route represented by Formula 5-3 shown below, a polymerizable iridium complex (2-(4-vinylphenyl)pyridine-iridium complex) A1 was synthesized.

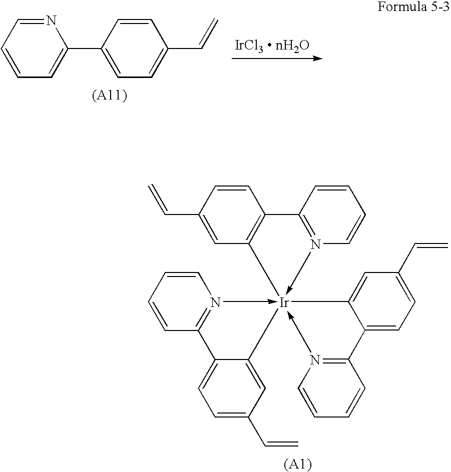

First, iridium (III) trichloride hydrate (300 mg) and the above synthesized 2-(4-vinylphenyl)pyridine All (4.5 g, 25 mmol) were added into ethylene glycol (40 mL). Then, nitrogen bubbling was performed in the mixed solution.

Next, the mixed solution was heated to reflux for six hours using a mantle heater under a nitrogen air flow.

Then, after cooling the reaction solution down to a room temperature, a resulting solid precipitate was filtered and washed with water and then xylene. The solid precipitate was dried under reduced pressure to obtain the polymerizable iridium complex A1 (yield: 48%).

The synthesis of the polymerizable iridium complex Al was confirmed using techniques such as Proton Nuclear Magnetic Resonance (¹H-NMR) spectroscopy and Fourier Transform Infrared (FT-IR) spectrophotometry.

Synthesis of a polymerizable iridium complex A2 expressed by Formula 6-1 shown below:

The polymerizable iridium complex A2 is a compound emitting green light.

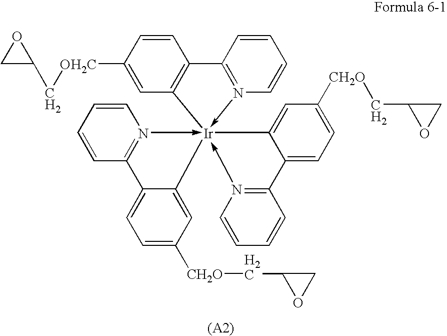

First, through a synthetic route represented by formula 6-2 shown below, a benzyl ether boronic acid derivative A23 was synthesized.

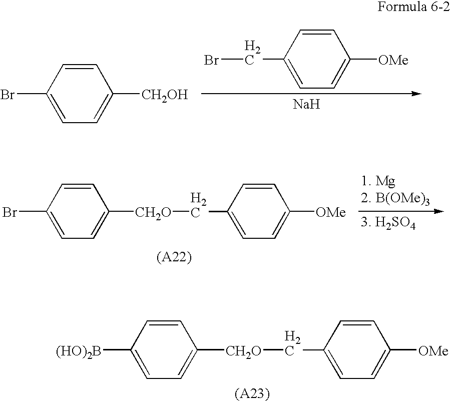

First, 4-bromobenzyl alcohol (1 mol) was treated with 4-metoxybenzyl bromide and sodium hydride in anhydrous dimethylformamide, whereby the hydroxyl group was converted into a 4-metoxybenzyl ether group to obtain a 4-bromobenzyl ether derivative A22.

Next, the synthesized 4-bromobenzyl ether derivative A22 (15 mmol) and metallic magnesium (20 mmol) were dissolved in anhydrous tetrahydrofuran (THF) to prepare a Grignard reagent.

Next, under a nitrogen gas atmosphere, while maintaining the reaction mixture solution at 15 degrees below zero, anhydrous THF containing trimethoxyboronic acid (15 mmol) was dropped slowly and stirred for an hour at the maintained temperature.

Then, 10 g of sulfuric acid aqueous solution (10%) was added to the reaction mixture and stirred for 24 hours while returning it to a room temperature.

Thereafter, the THF was removed under reduced pressure from the reaction mixture and an ether/pure water mixture was added thereto to obtain an aqueous layer with ether.

Next, after adding anhydrous magnesium sulfate to the obtained organic layer and drying it, the solvent was condensed under reduced pressure and a solid precipitate was taken out and recrystallized from xylene. As a result, the benzyl ether boronic acid derivative A23 (yield: 60%) was obtained.

The synthesis of the benzyl ether boronic acid derivative A23 was confirmed using techniques such as ¹H-NMR spectroscopy and FT-IR spectrophotometry.

Next, through a synthetic route represented by Formula 6-3 shown below, 2-(4-(4-methoxybenzyloxy)methylphenyl)pyridine A21 was synthesized.

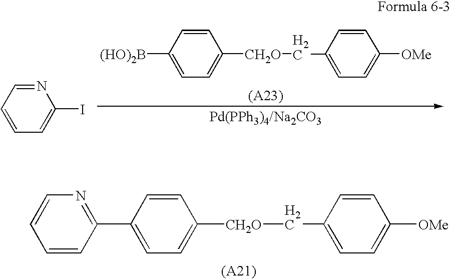

First, tetrakis(triphenylphosphine)palladium (0) (1 mmol) and the synthesized benzyl ether boronic acid derivative A23 (10 mmol) were added into a xylene solution containing 2-iodopyridine (10 mmol) and stirred.

Next, under a nitrogen atmosphere, a sodium hydrogen carbonate solution was added in the mixed solution and heated to reflux for 15 hours.

Then, a methylene chloride/water mixture was added to the reaction mixture to extract an aqueous layer with methylene chloride.

Next, after drying an obtained organic layer with anhydrous magnesium sulfate, the solvent was condensed under reduced pressure and a solid precipitate was recrystallized from xylene to obtain the 2-(4-(4-methoxybenzyloxy)methylphenyl)pyridine A21 (yield: 58%).

Next, through a synthetic route represented by Formula 6-4 shown below, an iridium complex A24 was synthesized.

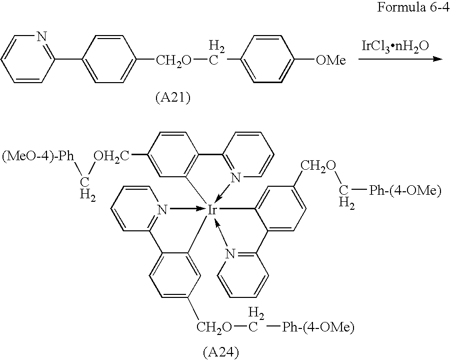

First, iridium (III) trichloride hydrate (300 mg) and the above synthesized pyridine derivative A21 (6.9 g, 25 mmol) were added to ethylene glycol (50 mL). Then, nitrogen bubbling was performed in the mixed solution.

Next, the mixed solution was heated to reflux for six hours using a mantle heater under a nitrogen air flow.

Then, after cooling the reaction solution down to a room temperature, a solid precipitate was filtered and washed with water and then xylene. The solid precipitate was dried under reduced pressure to obtain the iridium complex A24.

Next, through a synthetic route represented by Formula 6-5 shown below, a polymerizable iridium complex (2-(4-(glycidyloxymethyl)phenylpyridine-iridium complex) A2 was obtained.

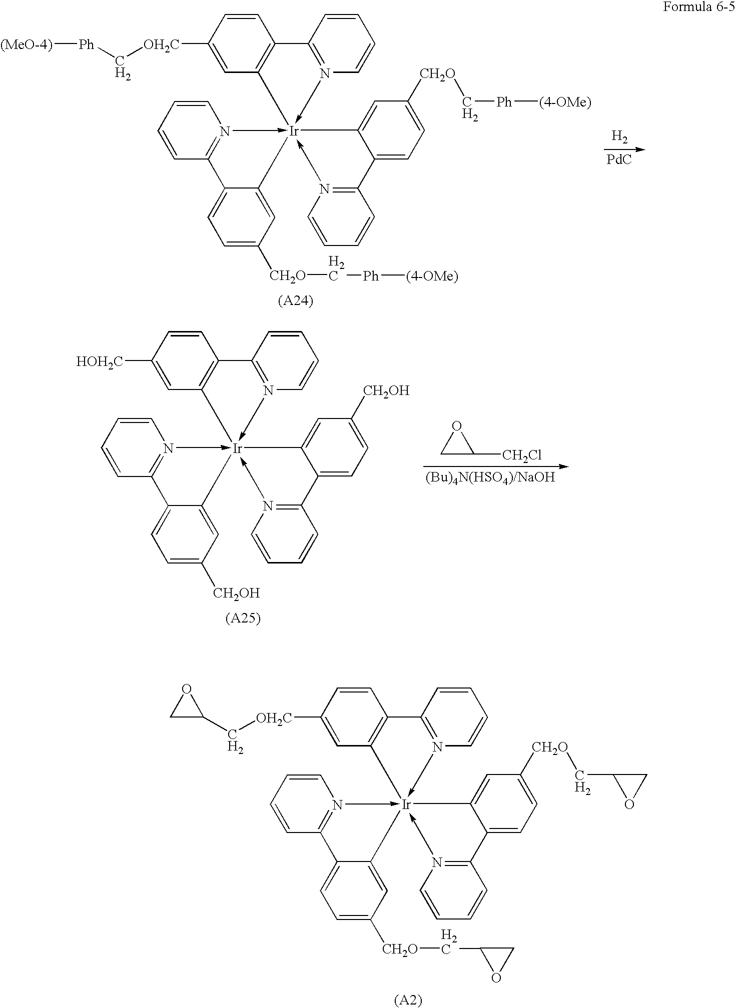

First, the obtained iridium complex A24 (10 mmol) and 0.5 g of palladium carbon was added to a xylene/ethyl acetate mixture solution (150 mL) and hydrogen reduction was performed under a nitrogen atmosphere. This allowed deprotection of the benzyl group, whereby the 2-(4-(glycidyloxymethyl)phenylpyridine-iridium complex) A25 was obtained.

Next, after adding the reaction solution into a 50% aqueous sodium hydroxide solution containing epichlorohydrin (30 g) and a small amount of tetrabutylammonium hydrogen sulfate (phase-transfer-catalyst), the mixture was stirred for 12 hours at a room temperature.

Next, the reaction solution was filtered to obtain a solid precipitate, which was purified with xylene/methanol a couple of times to obtain the polymerizable iridium complex A2.

The synthesis of the polymerizable iridium complex A2 was confirmed using techniques such as ¹H-NMR spectroscopy and FT-IR spectrophotometry.

Synthesis of a polymerizable iridium complex A3 expressed by

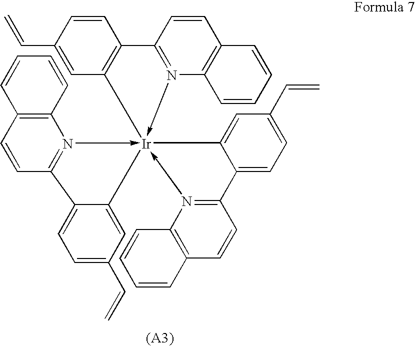

The polymerizable iridium complex A3 is a compound emitting red light. The polymerizable iridium complex (2-(4-vinylphenyl)quinoline-iridium complex) A3 was synthesized in the same manner as the polymerizable iridium complex A1, except that 2-chloroquinoline was used instead of 2-iodopyridine.

The synthesis of the polymerizable iridium complex A3 was confirmed using techniques such as ¹H-NMR spectroscopy and FT-IR spectrophotometry.

Synthesis of a polymerizable iridium complex A4 expressed by Formula 8 shown below.

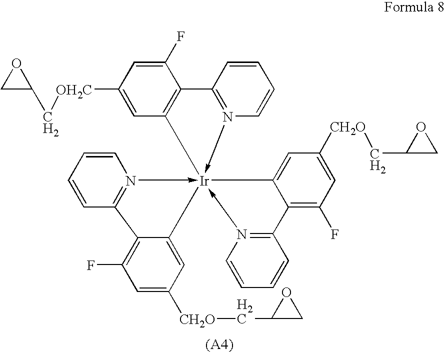

The polymerizable iridium complex A4 is a compound emitting blue light.

The polymerizable iridium complex (2-(2-fluoro-4-glycidyl oxymethylphenyl)pyridine-iridium complex) A4 was synthesized in the same manner as the polymerizable iridium complex A2, except that 4-bromo-2-fluorobenzylbromide was used instead of 4-bromobenzyl alcohol.

The synthesis of the polymerizable iridium complex A4 was confirmed using techniques such as 1H-NMR spectroscopy and FT-IR spectrophotometry.

Synthesis of a polymerizable iridium complex A5 expressed by

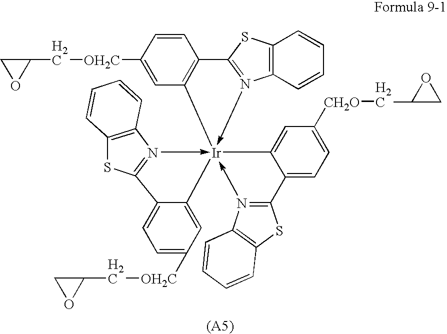

The polymerizable iridium complex A5 is a compound emitting red light.

First, through a synthetic route represented by Formula 9-2 shown below, 2-(4-benzyloxymethylphenyl)-1,3-benzothiazole A51 was synthesized.

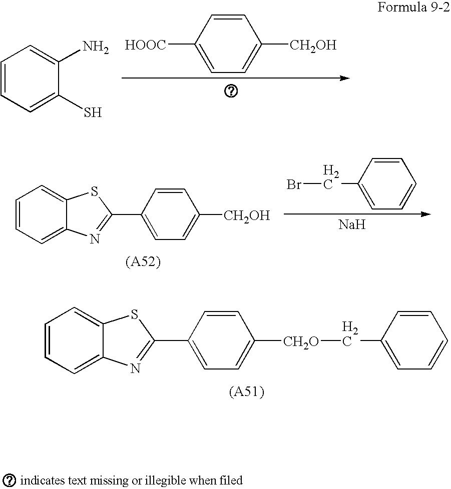

First, 4-hydroxymethyl benzoic acid (10 mmol) and 2-aminothiophenol (10 mmol) were added to polyphosphoric acid (50 g), and the mixture was stirred vigorously.

Next, the mixed solution was heated slowly up to 250 degrees centigrade and stirred under the same temperature for 4 hours.

Then, after cooling the reaction solution down to 100 degrees centigrade, a large amount of pure water was poured into the solution while stirring it.

Next, after a solid precipitate was filtered and washed with a small amount of pure water, the precipitate was added to a 10% aqueous sodium carbonate solution, stirred again and filtered. The filtrate was washed with pure water until the wash water was neutral, and then dried to obtain 2-(4-hydroxymethylphenyl)-1,3-benzothiazole A52.

Next, in order to protect a hydroxyl group with a benzyl group, the hydroxyl group was treated with benzylbromide and sodium hydroxide in anhydrous dimethylformamide to be converted into a benzyl ether group. As a result, the 2-(4-benzyloxymethylphenyl)-1,3-benzothiazole A51 was obtained.

Next, through the same synthetic route as in Formulas 6-4 and 6-5 above, a polymerizable iridium complex (2-(4-(glycidyloxymethylphenyl)-1,3-benzothiazole-iridium complex A5 was synthesized.

The synthesis of the polymerizable iridium complex A5 was confirmed using techniques such as ¹H-NMR spectroscopy and FT-IR spectrophotometry.

Synthesis of a polymerizable iridium complex A6 expressed by Formula 10-1 shown below.

Formula 10-1

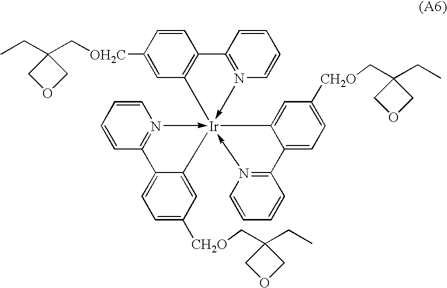

The polymerizable iridium complex A6 is a compound emitting green light.

First, through the synthetic routes represented by Formulas 6-1 to 8 above, the 2-(4-(hydroxymethyl)phenyl)pyridine-iridium complex A25 was synthesized.

Next, through a synthetic route represented by Formula 10-2 shown below, a polymerizable iridium complex 2-[4-(2-oxetanylbutyloxymethyl)phenyl]pyridine-iridium complex A6 was synthesized.

Formula 10-2

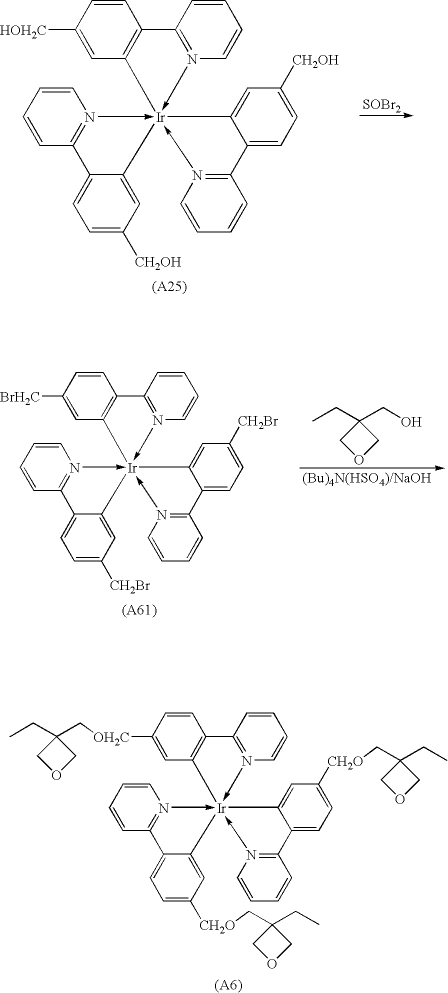

First, the synthesized 2-(4-(hydroxymethyl)phenyl)pyridine-iridium complex A25 and thionylbromide were mixed and the mixed solution was heated to obtain a 2-(4-(bromomethyl)phenyl)pyridine-iridium complex A61.

Next, the reaction solution was added to a 50% aqueous sodium hydroxide solution containing 3-ethyl-3-hydroxymethyloxetan and a small amount of tetrabutylammonium hydrogen sulfate (phase-transfer-catalyst), and then the mixture was stirred for 12 hours at a room temperature.

Next, the reaction solution was filtered to obtain a solid precipitate, which was purified with xylene/methanol a couple of times to obtain the polymerizable iridium complex A6.

The synthesis of the polymerizable iridium complex A6 was confirmed using techniques such as ¹H-NMR spectroscopy and FT-IR spectrophotometry.

Synthesis of a polymerizable aluminum complex A7 expressed by Formula 11-1 shown below.

Formula 11-1

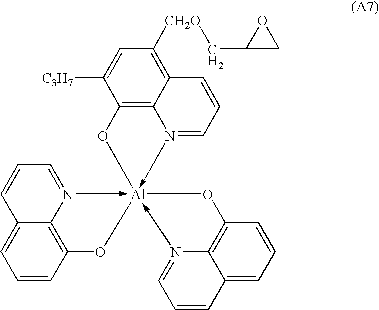

The polymerizable aluminum complex A7 is a compound emitting green light.

First, through a synthetic route represented by Formula 11-2 below, 5-hydroxymethyl-7-propyl-quinolinol A71 was synthesized.

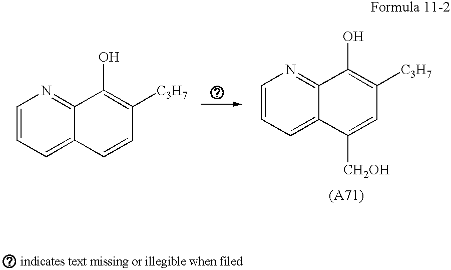

First, 7-propyl-8-quinolinol (20 mmol) and paraformaldehyde (0.75 g) were added into a 1,2-dimethoxyethane/xylene mixture solution (100 mL) and stirred.

Next, the mixed solution was heated to reflux at 135 degrees centigrade for 12 hours.

Then, after cooling it down to a room temperature, methanol was added to the reaction mixture and a solid precipitate was filtered. The precipitate was washed with a small amount of xylene, then separated and purified with silicagel column chromatography (methanol: dichloromethane=3:97) to obtain 5-hydroxymethyl-7-propyl-quinolinol A71 (yield: 23%).

Additionally, through a synthetic route represented by Formula 11-3 shown below, an aluminum complex A72 was synthesized.

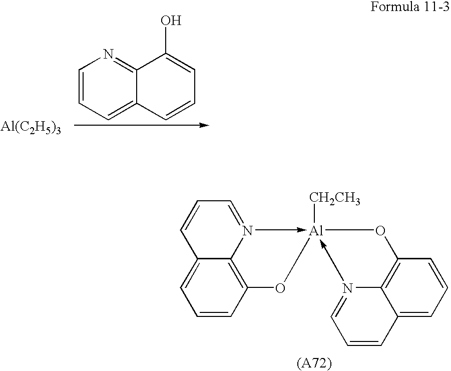

First, a toluene solution (100 mL) of 8-quinolinol (72 mmol) was dropped to a toluene solution (20 mL; 36 mmol) of a 25 wt % triethylaluminum at a room temperature for 1 hour.

Then, after stirring the mixture under the room temperature for 12 hours, a solid deposit was filtered. The filtrate was condensed under reduced pressure and the solid deposit was washed with a small amount of toluene to obtain the aluminum complex A72 (yield: 95%).

Next, through a synthetic route represented by Formula 11-4 below, aluminum complex alcohol A73 was synthesized.

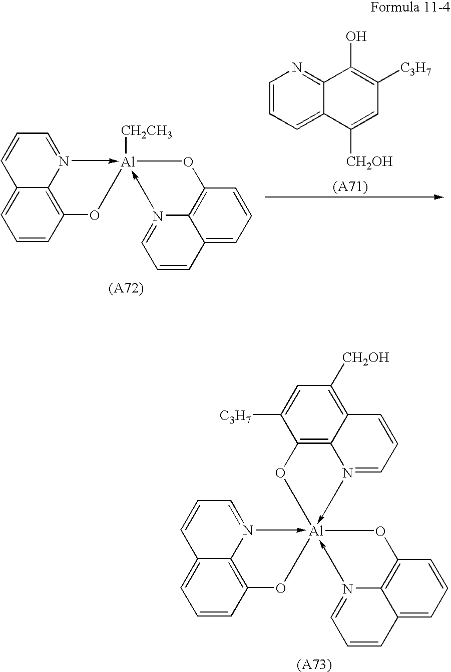

First, a xylene solution (15 mL) of the synthesized 8-quinolinol A71 (3 mmol) was dropped to a xylene solution (30 mL) of the synthesized aluminum complex A72 (3 mmol) at a room temperature for one hour.

Next, the reaction mixture was stirred at the room temperature for eight hours.

Then, the reaction mixture was condensed under reduced pressure and a solid precipitate was washed with a small amount of xylene.

Next, the obtained solid was recrystallized from methylene chloride to obtain the aluminum complex-alcohol A73.

Next, thorough the same synthetic route as Formula 6-5 above, an epoxy group was introduced to obtain a polymerizable aluminum complex A7.

The synthesis of the polymerizable aluminum complex A7 was confirmed using techniques such as ¹H-NMR spectroscopy and FT-IR spectrophotometry.

Synthesis of a polymerizable aluminum complex A8 expressed by Formula 12 shown below.

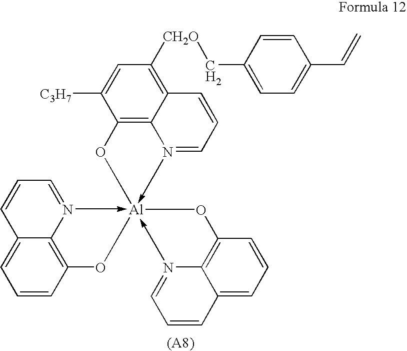

The above polymerizable aluminum complex A8 is a compound emitting green light.

The polymerizable aluminum complex A8 was synthesized in the same manner as the polymerizable aluminum complex A7, except that 4-vinylbenzylchloride was used instead of epichlorohydrin.

Synthesis of a polymerizable vinylcarbazole-styrene copolymer B1 expressed by Formula 13-1 shown below.

Formula 13-1

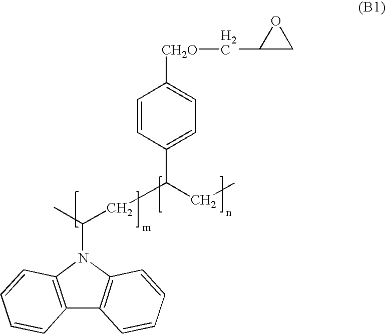

First, through a synthetic route represented by Formula 13-2 below, a 4-vinylbenzylether derivative (styrene derivative) B11 was synthesized.

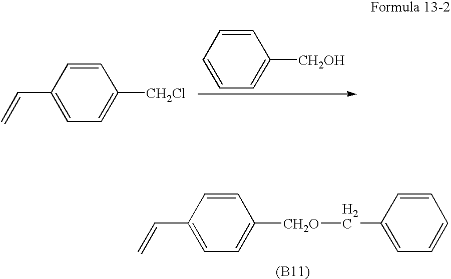

The polymerizable vinylcarbazole-styrene copolymer B1 is a compound emitting blue light.

The 4-vinylbenzylether derivative B11 was synthesized from 4-vinylbenzylchloride (manufactured by Sigma-Aldrich Co.) and benzyl alcohol.

Next, through a synthetic route represented by Formula 13-3 below, an ether derivative B12 of vinylcarbazole-styrene copolymer was synthesized.

Formula 13-3

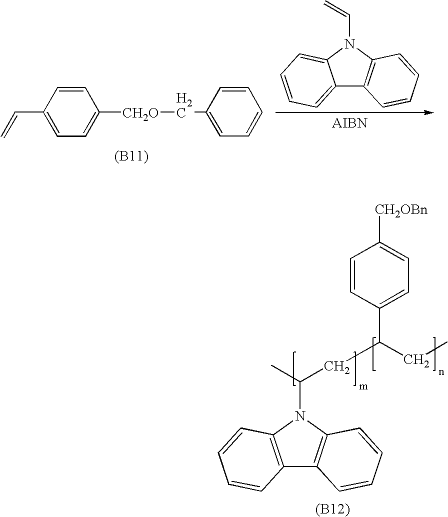

First, a xylene mixture solution (300 mL) containing a 4-vinylbenzylether derivative (10 mmol) and an N-vinylcarbazole (100 mmol: Tokyo Chemical Industry Co., Ltd.) was prepared to add azoiso-butyronitrile (AIBN: 1 mmol) thereto.

Next, after removing dissolved oxygen by nitrogen bubbling, the mixture was heated while stirring at 80 degrees centigrade for 12 hours.

Then, methanol was added to the reaction mixture solution to obtain a solid precipitate.

Next, the precipitate was redissolved in xylene to be extracted with methanol. After repeating the dissolution and extraction thereof twice, the solvent was removed to obtain the benzylether derivative B12 of the vinylcarbazole-styrene copolymer.

Next, through the same synthetic route as Formula 6-5 above, an epoxy group was introduced to obtain a polymerizable vinylcarbazole-styrene copolymer (epoxy-containing vinylcarbazole-styrene copolymer) B1.

The synthesis of the polymerizable vinylcarbazole-styrene copolymer B1 was confirmed using techniques such as ¹H-NMR spectroscopy and FT-IR spectrophotometry.

Synthesis of a polymerizable vinylcarbazole-styrene copolymer B2 expressed by Formula 14 shown below.

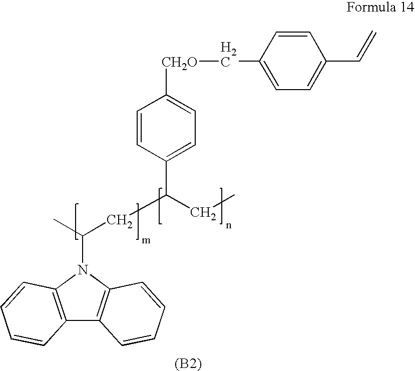

The polymerizable vinylcarbazole-styrene copolymer B2 was synthesized in the same manner as the polymerizable vinylcarbazole-styrene copolymer B1, except that 4-vinylbenzylchloride was used instead of epichlorohydrin.

Synthesis of a polymerizable oxadiazole derivative C1 expressed by Formula 15-1 below.

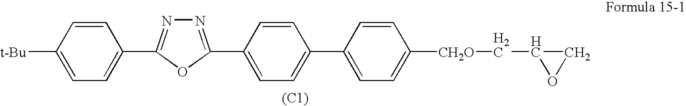

First, through a synthetic route represented by Formula 15-2 below, biphenylcarboxylic acid ethyl ester C13 was synthesized.

Formula 15-2

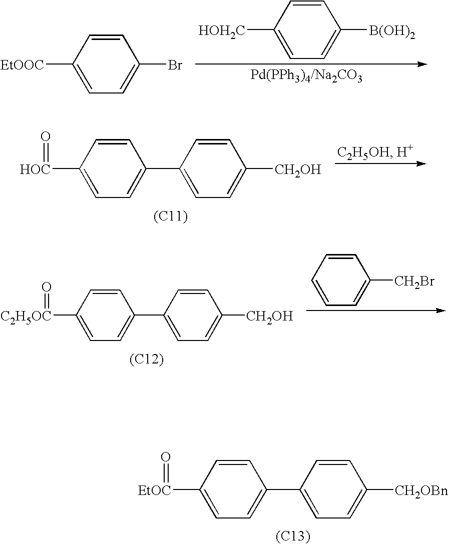

First, a toluene solution of 4-bromobenzoic acid methyl (10 mmol), tetrakis(triphenylphosphine)palladium (0) (3 mmol) and 4-(hydroxymethyl)phenylboronic acid (10 mmol: manufactured by Sigma-Aldrich Co.) were mixed and stirred.

Next, a sodium carbonate aqueous solution was added to the mixed solution and the mixture was refluxed for 24 hours.

Next, after reaction was completed, a methylene chloride/water mixture was added to the reaction mixture to extract an aqueous layer with an organic solvent. After drying the extract with anhydrous magnesium sulfate, extra solvent was removed under reduced pressure to obtain a biphenyl carbonic acid derivative C11 (yield: 60%).

Next, the biphenyl carbonic acid derivative C11 was reacted with ethanol under the acidity of sulfuric acid, whereby a carboxyl group was ethylesterified (C12). Then, due to reaction with benzylbromide, a hydroxyl group was converted into a benzyl protecting group to obtain a biphenyl carbonic acid ethyl ester derivative (C13).

Next, through a synthetic route represented by Formula 15-3 below, a biphenyl carbonic acid hydrazide derivative C14 was synthesized.

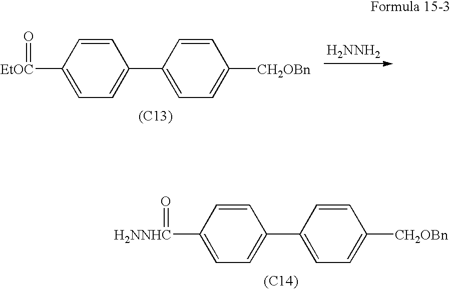

An ethanol suspension of the synthesized biphenyl carbonic acid ethyl ester derivative C13 (10 mmol) was reacted with a hydrazine aqueous solution to obtain the biphenyl carbonic acid hydrazine derivative C14.

Next, through a synthetic route represented by Formula 15-4 shown below, a hydrazine intermediate (C15) was synthesized.

Formula 15-4

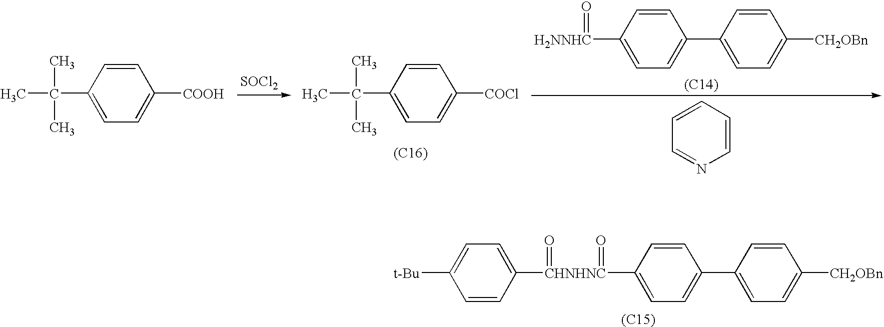

First, 4-t-butyl benzoic acid (10 mmol) and thionyl chloride (25 mL) were placed in a thoroughly dried flask and heated to reflux gently under a nitrogen air flow for 5 hours to obtain 4-t-butylbenzoyl chloride C16.

Next, after removing extra thionyl chloride under reduced pressure, pyridine 100 mL was added to the synthesized 4-t-butylbenzoyl chloride C16 at a room temperature, as well as the synthesized biphenyl carbonic acid hydrazide derivative C14 (10 mmol) was added gradually. As a result, exothermic reaction of the system occurred, whereby the suspension changed into a homogeneous solution.

Next, the mixture solution was stirred at a room temperature for 30 minutes under a nitrogen air flow, and then was stirred for 3 more hours while heating it in an oil bath at 50 degrees centigrade.

Next, an obtained reaction solution was poured into a large amount of ice water to extract powdery solid product. The powdery solid was filtered, washed with water and then methanol and dried to obtain the hydrazine intermediate C15 (yield: 75%).

Next, through a synthetic route represented by Formula 15-5 below, an oxadiazole derivative C17 was synthesized.

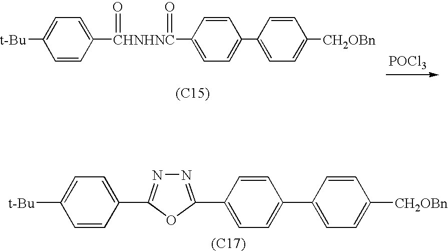

First, 10 mL of phosphoryl chloride was added to an anhydrous xylene solution containing the synthesized hydrazine intermediate C15 (10 mmol) and heated to reflux for 6 hours gently under a nitrogen air flow. Thereby, dehydration of the hydrazine intermediate was carried out.

Next, a large amount of xylene and phosphoryl chloride in the obtained reaction solution was removed by distillation under reduced pressure. Thereafter, while cooling, a large amount of water was added to the solution carefully to prepare a suspension.

Then, after neutralizing the obtained suspension with a sodium hydroxide aqueous solution, it was filtered to obtain powdery product. The product was washed with water and then methanol and dried to obtain the oxadiazole derivative C17 (yield: 65%).

Next, an epoxy group was introduced through the same synthetic route as Formula 6-5 above to obtain a polymerizable oxadiazole derivative C1.

The synthesis of the polymerizable oxadiazole derivative C1 was confirmed by using techniques such as ¹H-NMR spectroscopy and FT-IR spectrophotometry.

Synthesis of a polymerizable oxadiazole derivative C2 expressed by Formula 16 shown below.

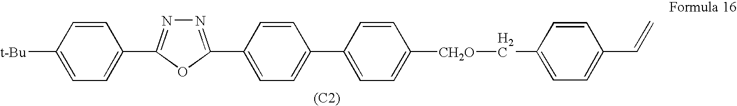

The polymerizable oxadiazole derivative C2 was synthesized in the same manner as the polymerizable oxadiazole derivative C1, except that 4-vinylbenzylchloride was used instead of epichlorohydrin.

Synthesis of a polymerizable triphenylamine derivative D1 expressed by Formula 17-1 shown below.

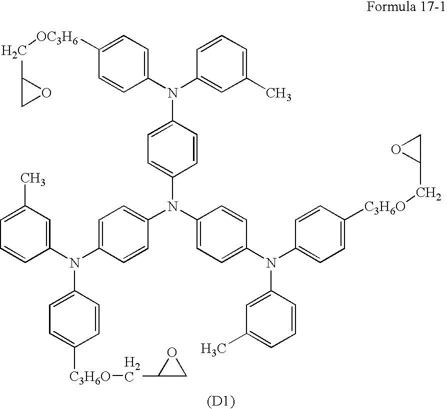

First, through a synthetic route represented by Formula 17-2 shown below, a benzylether derivative D11 was synthesized.

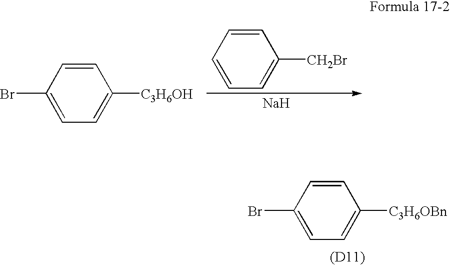

Next, 3-(p-bromophenyl)propanol was treated with benzylbromide and sodium hydroxide in anhydrous dimethylformamide, whereby a hydroxyl group was converted into a benzylether group to obtain the benzylether derivative D11.

Meanwhile, through a synthetic route represented by Formula 17-3 shown below, a 3-methylbenzamide derivative D12 was synthesized.

Formula 17-3

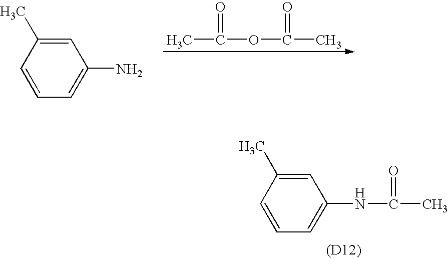

First, m-toluidine (1 mol) was dissolved in 150 mL of acetic acid. Under a room temperature, anhydrous acetic acid was dropped to the solution and stirred.

Next, after reaction was completed, a solid precipitate was filtered, washed and then dried to obtain the 3-methylbenzamide derivative D12.

Next, through a synthetic route represented by Formula 17-4 shown below, a diphenylamine derivative D13 was synthesized.

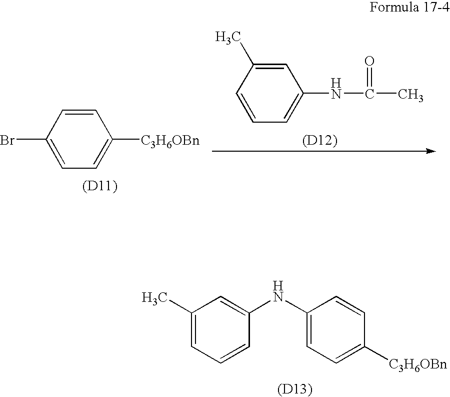

First, a benzylether derivative D11 (0.5 mol), a 3-methylbenzamide derivative D12 (0.6 mol), potassium carbonate (1.1 mol), copper powder and iodine were mixed and heated at 200 degrees centigrade.

Next, after cooling the mixture, 130 mL of isoamyl alcohol, 50 mL of pure water and 0.73 mol of potassium hydroxide were added thereto and the mixture solution was stirred and dried to obtain the diphenylamine derivative D13.

Next, through a synthetic route represented by Formula 17-5 shown below, a triphenylamine derivative D14 was synthesized.

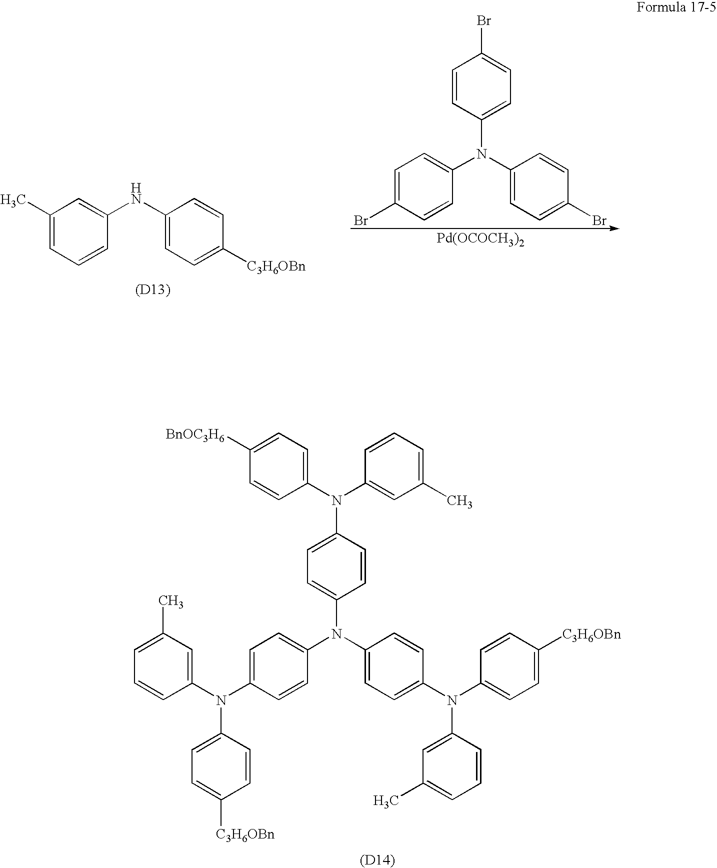

First, the synthesized diphenylamine derivative D13 (200 mmol), tris(4-bromophenyl)amine (60 mmol), acetic acid palladium (2.1 mmol), t-butylphosphine (8.4 mmol), t-butoxy sodium (400 mmol) and xylene (600 mL) were mixed and stirred at 120 degrees centigrade.

Next, after allowing the reaction solution to cool down, a solid precipitate was filtered and washed with a small amount of xylene to obtain the triphenylamine derivative D14.

Next, an epoxy group was introduced through the same synthetic route as in Formula 6-5 above to obtain a polymerizable triphenylamine derivative D1.

The synthesis of the polymerizable triphenylamine derivative D1 was confirmed using techniques such as ¹H-NMR spectroscopy and FT-IR spectrophotometry.

Synthesis of a polymerizable triphenylamine derivative D2 expressed by Formula 18 shown below.

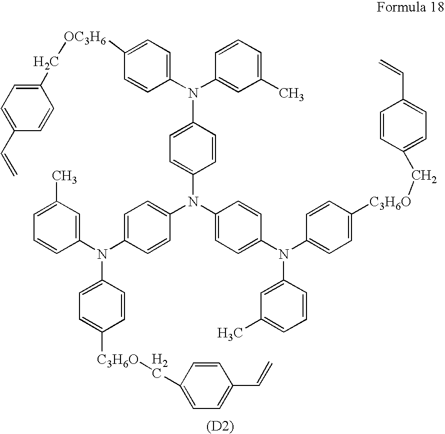

The above polymerizable triphenylamine derivative D2 was synthesized in the same manner as the polymerizable triphenylamine derivative D1, except that 4-vinylbenzylchloride was used instead of epichlorohydrin.

Synthesis of a polymerizable arylamine derivative E1 expressed by Formula 19-1 shown below.

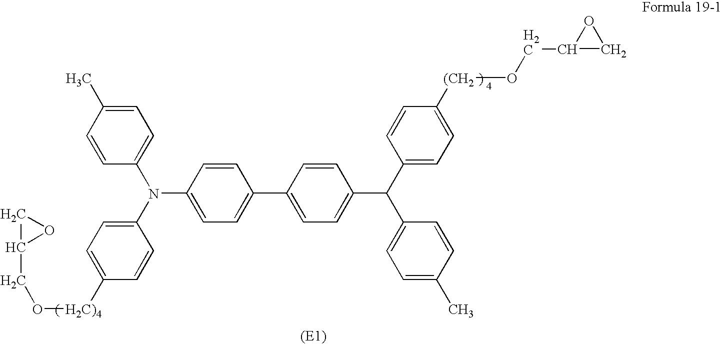

First, through a synthetic route represented by Formula 19-2 shown below, a benzylether derivative E11 was synthesized.

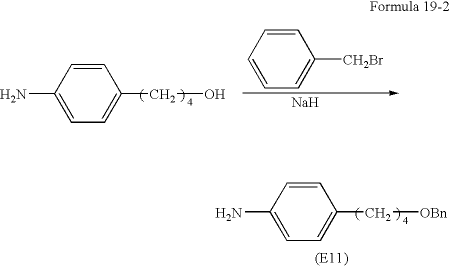

In anhydrous dimethylformamide, 1-(p-aminophenyl)butanol was treated with benzylbromide and sodium hydride, where a hydroxyl group was converted into a benzylether group to obtain the benzylether derivative E11.

Next, through a synthetic route represented by Formula 19-3 shown below, a benzamide derivative E12 was synthesized from the benzylether derivative E11.

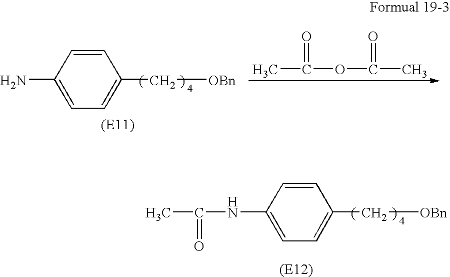

First, after dissolving the benzyl ether derivative E11 (1 mol) in 150 mL of acetic acid, anhydrous acetic acid was dropped to the solution under a room temperature and stirred.

Next, after reaction was completed, a solid precipitate was filtered, washed and then dried to obtain the benzamide derivative E12.

Next, through a synthetic route represented by Formula 19-4 shown below, a diphenylamine derivative E13 was synthesized.

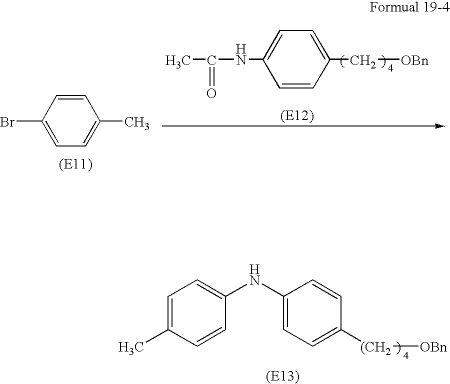

First, 4-bromotoluene (0.5 mol), the benzamide derivative E12 (0.6 mol), potassium carbonate (1.1 mol), copper powder and iodine were mixed and heated at 200 degrees centigrade.

Next, after allowing the mixture to cool down, 130 mL of isoamyl alcohol, 50 mL of pure water and 0.73 mol of potassium hydroxide were added thereto, stirred and dried to obtain the diphenylamine derivative E13.

Next, through a synthetic route represented by Formula 19-5 shown below, an arylamine derivative E14 was synthesized.

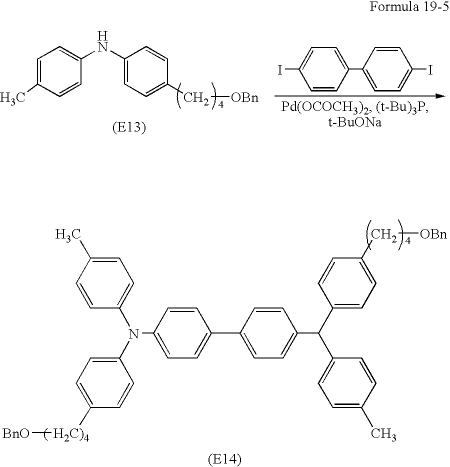

First, the synthesized diphenylamine derivative E13 (130 mmol), 4,4′-diodobiphenyl (62 mmol), acetic acid palladium (1.3 mmol), t-butylphosphine (5.2 mmol), t-butoxy sodium (260 mmol) and xylene (700 mL) were mixed and stirred at 120 degrees centigrade.

Next, after allowing the reaction solution to cool down, a solid precipitate were filtered and washed with a small amount of xylene to obtain the arylamine derivative E14.

Next, an epoxy group was introduced through the same synthetic route as in Formula 6-5 above to obtain a polymerizable arylamine derivative E1.

The synthesis of the polymerizable arylamine derivative E1 was confirmed using techniques such as ¹H-NMR spectroscopy and FT-IR spectrophotometry.

Synthesis of a polymerizable arylamine derivative E2 expressed by Formula 20 shown below.

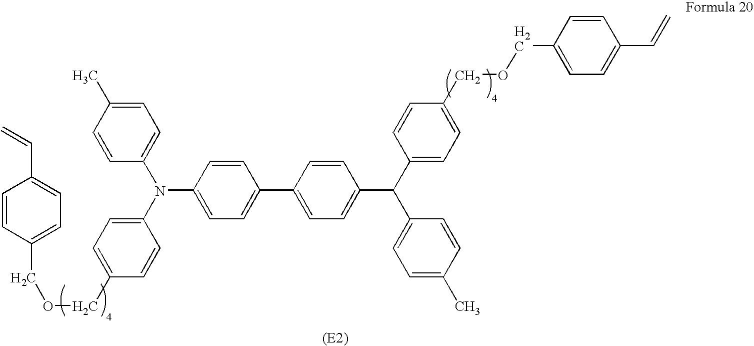

The polymerizable arylamine derivative E2 was synthesized in the same manner as the polymerizable arylamine derivative E1, except that 4-vinylbenzylchloride was used instead of epichlorohydrin.

2. Preparation of Liquid Material

2-1. Preparation of Red Liquid Material

Preparation of a Red Liquid Material R1

There were used the polymerizable iridium complex A3 as the first light emitting compound that includes the light emitting moiety having red-luminescent characteristics; the polymerizable triphenylamine derivative D2 (hole transporting compound) and the polymerizable oxadiazole derivative C2 (electron transporting compound) as the first carrier transporting compounds, which both include carrier transporting moieties having carrier transporting characteristics; the polymerizable vinylcarbazole-styrene copolymer B2 as the host compound that includes the host portion supplying excitation energy to the light emitting moiety; and a photo-radical polymerization initiator (“Irugacure 651” by Nagase Sangyo K.K.) as a photopolymerization initiator. Those compounds were dissolved in xylene to prepare a red liquid material R1 of 1.0 wt %.

A mix ratio among the first light emitting compound, the first carrier transporting compounds and the host compound was set to be a weight ratio of 6:30:70. In addition, a ratio (weight ratio) between a total weight of the first light emitting compound, the first carrier transporting compounds and the host compound and a weight of the photo-radical polymerization initiator was set to be 99:1.

Preparation of a Red Liquid Material R2

There were used the polymerizable iridium complex A5 as the first light emitting compound emitting red light; the polymerizable triphenylamine derivative D1, the polymerizable arylamine derivative E1 (both of which are hole transporting compounds) and the polymerizable oxadiazole derivative C1 (electron transporting compound) as the first carrier transporting compounds; the polymerizable vinylcarbazole-styrene copolymer B1 as the host compound; and a photo-cationic polymerization initiator (“FC-508” by Sumitomo 3M Limited.) as the photopolymerization initiator. Those compounds were dissolved in xylene to prepare a red liquid material R2 of 1.0 wt %.

A mix ratio among the first light emitting compound, the first carrier transporting compounds and the host compound was set to be a weight ratio of 6:30:70. In addition, a ratio (weight ratio) between a total weight of the first light emitting compound, the first carrier transporting compounds and the host compound and a weight of the photo-cationic polymerization initiator was set to be 99:1.

2-2. Preparation of Green Liquid Material

Preparation of a Green Liquid Material G1

There were used the polymerizable iridium complex A1 as the second light emitting compound emitting green light; the polymerizable arylamine derivative E2 (hole transporting compound) and the polymerizable oxadiazole derivative C2 (electron transporting compound) as the second carrier transporting compounds; the polymerizable vinylcarbazole-styrene copolymer B2 as the host compound; and the photo-radical polymerization initiator (“Irugacure 651” by Nagase Sangyo, K.K.) as the photopolymerization initiator. Those compounds were dissolved in xylene to prepare a green liquid material G1 of 1.0 wt %.

A mix ratio among the second light emitting compound, the second carrier transporting compounds and the host compound was set to be a weight ratio of 6:30:70. In addition, a ratio (weight ratio) between a total weight of the second light emitting compound, the second carrier transporting compounds and the host compound and a weight of the photo-radical polymerization initiator was set to be 99.5:0.5.

Preparation of a Green Liquid Material G2

There were used the polymerizable iridium complex A2 as the second light emitting compound emitting green light; the polymerizable arylamine derivative E1 (hole transporting compound) and the polymerizable oxadiazole derivative C1 (electron transporting compound) as the second carrier transporting compounds; the polymerizable vinylcarbazole-styrene copolymer B1 as the host compound; and the photo-cationic polymerization initiator (“FC-508” by Sumitomo 3M Limited.) as the photopolymerization initiator. Those compounds were dissolved in xylene to prepare a green liquid material G2 of 1.0 wt %.

A mix ratio among the second light emitting compound, the second carrier transporting compounds and the host compound was set to be a weight ratio of 3:30:70. In addition, a ratio (weight ratio) between a total weight of the second light emitting compound, the second carrier transporting compounds and the host compound and a weight of the photo-cationic polymerization initiator was set to be 99:1.

Preparation of a Green Liquid Material G3

There were used the polymerizable iridium complex A6 as the second light emitting compound emitting green light; the polymerizable triphenylamine derivative D1, the polymerizable arylamine derivative E1 (both of which are hole transporting compounds) and the polymerizable oxadiazole derivative C1 (electron transporting compound) as the second carrier transporting compounds; the polymerizable vinylcarbazole-styrene copolymer B1 as the host compound; and the photo-cationic polymerization initiator (“FC-508” by Sumitomo 3M Limited.) as the photopolymerization initiator. Those compounds were dissolved in xylene to prepare a green liquid material G3 of 1.0 wt %.

A mix ratio among the second light emitting compound, the second carrier transporting compounds and the host compound was set to be a weight ratio of 3:30:70. In addition, a ratio (weight ratio) between a total weight of the second light emitting compound, the second carrier transporting compounds and the host compound and a weight of the photo-cationic polymerization initiator was set to be 99:1.

Preparation of a Green Liquid Material G4

There were used the polymerizable aluminum complex A7 as the second light emitting compound emitting green light; the polymerizable triphenylamine derivative D1, the polymerizable arylamine derivative E1 (both of which are hole transporting compounds) and the polymerizable oxadiazole derivative C1 (electron transporting compound) as the second carrier transporting compounds; and the photo-cationic polymerization initiator (“FC-508” by Sumitomo 3M Limited.) as the photopolymerization initiator. Those compounds were dissolved in xylene to prepare a green liquid material G4 of 1.0 wt %.

A mix ratio between the second light emitting compound and the second carrier transporting compounds was set to be a weight ratio of 30:70. In addition, a ratio (weight ratio) between a total weight of the second light emitting compound and the second carrier transporting compounds and a weight of the photo-cationic polymerization initiator was set to be 99:1.

Preparation of a Green Liquid Material G5

There were used the polymerizable aluminum complex A8 as the second light emitting compound emitting green light; the polymerizable arylamine derivative E2 (hole transporting compound) and the polymerizable oxadiazole derivative C2 (electron transporting compound) as the second carrier transporting compounds; and the photo-radical polymerization initiator (“Irugacure 651” by Nagase Sangyo K.K.) as the photopolymerization initiator. Those compounds were dissolved in xylene to prepare a green liquid material G5 of 1.0 wt %.

A mix ratio between the second light emitting compound and the second carrier transporting compounds was set to be a weight ratio of 30:70. In addition, a ratio (weight ratio) between a total weight of the second light emitting compound and the second carrier transporting compounds and a weight of the photo-radical polymerization initiator was set to be 99.5:0.5.

2-3. Preparation of Blue Liquid Material

Preparation of a Blue Liquid Material B1

There were used the polymerizable iridium complex A4 as the third light emitting compound emitting blue light; the polymerizable triphenylamine derivative D1 (hole transporting compound) and the polymerizable oxadiazole derivative C1 (electron transporting compound) as the third carrier transporting compounds; the polymerizable vinylcarbazole-styrene copolymer B1 as the host compound and the photo-cationic polymerization initiator (“FC-508” by Sumitomo 3M Limited.) as the photopolymerization initiator. Those compounds were dissolved in xylene to prepare a blue liquid material B1 of 1.0 wt %.

A mix ratio among the third light emitting compound, the third carrier transporting compounds and the host compound was set to be a weight ratio of 6:30:70. In addition, a ratio (weight ratio) between a total weight of the third light emitting compound, the third carrier transporting compounds and the host compound and a weight of the photo-cationic polymerization initiator was set to be 99:1.

Preparation of a Blue Liquid Material B2

There were used the polymerizable vinylcarbazole-styrene copolymer B1 as the third light emitting compound emitting blue light; the polymerizable triphenylamine derivative D1, the polymerizable arylamine derivative E1 (both of which are hole transporting compounds) and the polymerizable oxadiazole derivative C1 (electron transporting compound) as the third carrier transporting compounds; and the photo-cationic polymerization initiator (“FC-508” by Sumitomo 3M Limited.) as the photopolymerization initiator. Those compounds were dissolved in xylene to prepare a blue liquid material B2 of 1.0 wt %.

A mix ratio between the third light emitting compound and the third carrier transporting compounds was set to be a weight ratio of 70:30. In addition, a ratio (weight ratio) between a total weight of the third light emitting compound and the third carrier transporting compounds and a weight of the photo-cationic polymerization initiator was set to be 99:1.

3. Manufacturing of an Organic EL Light Emitting Device

### Example 1

1A. First, there was prepared a transparent glass substrate having a mean thickness of 5 mm. A circuit section was provided thereon in the manner as described above.

2A. Next, sputtering was performed on the circuit section to form an indium tin oxide (ITO) film having a mean thickness of 100 nm. Thereafter, photolithography and etching were performed to remove unnecessary part so as to form anodes (pixel electrodes).

3A. Next, the CVD process was performed to form a silicon oxide (SiO₂) film having a film thickness of 100 nm and etching was performed to form partitions so as to partition a region where anodes are in contact with light emitting layers to be formed later.

4A. Next, the first (red) light emitting layer was formed on the anode located at a position corresponding to a first region forming each red light emitting element.

First, the first coated film was formed so as to cover each anode by supplying the red liquid material G1 and then drying.

Next, UV light having a wavelength of 365 nm and an irradiation intensity of 2 mW/cm² was irradiated on the region for forming the first light emitting layer for 300 seconds under an argon gas atmosphere. The light was irradiated by filtering light from a mercury lamp (“UM-452 model” by Ushio Inc.) through a stainless steel plate (mask) having a thickness of 0.1 mm and having an opening formed at a position corresponding to the first region. This resulted in formation of the first light emitting layer composed of a random polymer.

Then, xylene was applied on the first coated film to remove the first coated film existing on a region not subjected to the UV irradiation.

5A. Next, the second (green) light emitting layer was formed on the anode located at a position corresponding to a second region for forming each green light emitting element.

First, the second coated film was formed so as to cover the anode by supplying the green liquid material G1 and then drying.

Next, UV light having a wavelength of 365 nm and an irradiation intensity of 2 mW/cm² was irradiated on the region for forming the second light emitting layer for 300 seconds under an argon gas atmosphere. The light was irradiated by filtering light from the mercury lamp (“UM-452 model” by Ushio Inc.) through a stainless steel plate (mask) having a thickness of 0.1 mm and having an opening at a position corresponding to each second region. This resulted in formation of the second light emitting layer composed of random polymer.

Then, xylene was applied on the second coated film to remove the second coated film existing on a region not subjected to the UV irradiation.

6A. Next, the third (blue) light emitting layer was formed on the anode located at a position corresponding to a third region for forming each blue light emitting element.

First, the third coated film was formed so as to cover the anode by supplying the blue liquid material B1 and then drying.

Next, UV light having a wavelength of 365 nm and an irradiation intensity of 500 mW/cm² was irradiated on the region for forming the third light emitting layer for 15 seconds under an argon gas atmosphere and then heated at 110 degrees centigrade for 60 minutes. The light was irradiated by filtering light from the mercury lamp (“UM-452 model” by Ushio Inc.) through a stainless steel plate (mask) having a thickness of 0.1 mm and having an opening at a position corresponding to each third region. This resulted in formation of the third light emitting layer composed of a random polymer.

Then, xylene was applied on the third coated film to remove the third coated film existing on a region not subjected to the UV irradiation.

7A. Next, using a vacuum deposition method, calcium (CA) and aluminum (Al) were sequentially supplied on each of the first to third light emitting layers to form a CaAl electrode (cathode) having a mean thickness of 300 nm thereon.

8A. Next, a protective cover made of polycarbonate was placed so as to cover each of the formed light emitting elements. The cover was fixed and sealed with a UV curable resin, whereby a light emitting device was completed.

### Example 2

There was manufactured a light emitting device in the same manner as in Example 1, except that, in the process 5A, the green liquid material G5 was used instead of the G1 as the liquid material for the second coated film.

### Example 3

There was manufactured a light emitting device in the same manner as in Example 1, except that, in the process 5A, the green liquid material G2 was used instead of the G1 as the liquid material for the second coated film and the conditions of UV irradiation were the same as those for the third coated film in the process 6A.

### Example 4

There was manufactured a light emitting device in the same manner as in Example 1, except that, in the process 4A, the red liquid material R2 was used instead of the R1 as the liquid material for the first coated film and the conditions of UV irradiation were the same as those for the third coated film in the process 6A; in the process 5A, the green liquid material G3 was used instead of the G1 as the liquid material for forming the second coated film and the conditions of UV irradiation were the same as those for the third coated film in the process 6A; and in the process 6A, the blue liquid material B2 was used instead of the B1 as the liquid material for forming the third coated film.

### Example 5

There was manufactured a light emitting device in the same manner as in Example 1, except that, in the process 4A, the red liquid material R2 was used instead of the R1 as the liquid material for the first coated film and the conditions of UV light irradiation were the same as those for the third coated film in the process 6A; in the process 5A, the green liquid material G4 was used instead of the G1 as the liquid material for forming the second coated film and the conditions of UV light irradiation were the same as those for the third coated film in the process 6A; and, in the process 6A, the blue liquid material B2 was used instead of the B1 as the liquid material for forming the third coated film.

In each of the above-described examples, a voltage of 6V was applied between the anode and the cathode to measure the light emitting brightness (cd/m²) and maximum light emitting efficiency (1 m/W) of each color (red, green and blue) light emitting element, as well as to measure a time (half-life period) in which the light emitting brightness thereof becomes half an initial value. In the results, all the light emitting elements obtained in the examples showed excellent values and luminescent characteristics.

The invention has been described through an exemplary embodiment and examples. However, various changes and modifications can be made without departing from the scope thereof as defined by the appended claims.

The entire disclosure of Japanese Patent Application No: 2006-077832, filed Mar. 20, 2006 is expressly incorporated by reference herein.

What is claimed is:

1. A method of manufacturing a light emitting device, comprising:
forming a first coated film including a first light emitting compound and a first carrier transporting compound over a first electrode, the first light emitting compound including a first light emitting moiety that has luminescent characteristics emitting light of a first color, the first light emitting compound including a first polymerizable group that has photopolymerization characteristics, the first carrier transporting compound including a first carrier transporting moiety that has carrier transporting characteristics, the first carrier transporting compound including a second polymerizable group that has photopolymerization characteristics;
forming a first light emitting layer by polymerizing between the first light emitting compound and the first carrier transporting compound by irradiating a first portion of the first coated film with a first light to harden the first portion of the first coated film;
removing a second portion of the first coated film, the second portion not being irradiated with the first light at the process of forming the first light emitting layer;
forming a second coated film including a second light emitting compound and a second carrier transporting compound over the first electrode, the second light emitting compound including a second light emitting moiety that has luminescent characteristics emitting light of a second color different from the first color, the second light emitting compound including a third polymerizable group that has photopolymerization characteristics, the second carrier transporting compound including a second carrier transporting moiety that has carrier transporting characteristics, the second light emitting compound including a fourth polymerizable group that has photopolymerization characteristics;
forming a second light emitting layer by polymerizing between the second light emitting compound and the second carrier transporting compound by irradiating a first portion of the second coated film with a second light to harden the first portion of the second coated film;
removing a second portion of the second coated film, the second portion not being irradiated with the second light at the process of forming the second light emitting layer; and
providing a second electrode over at least any one of the first and second light emitting layers.

2. The method of manufacturing a light emitting device according to claim 1, the first coated film being formed by a liquid phase process.

3. The method of manufacturing a light emitting device according to claim 1, a weight ratio between the first light emitting compound and the first carrier transporting compound being in a range from 1:100 to 90:10.

4. The method of manufacturing a light emitting device according to claim 1, at least one of the first and second polymerizable groups including a plurality of polymerizable groups.

5. The method of manufacturing a light emitting device according to claim 1, at least one of the first and second polymerizable groups including cationic polymerization characteristics.

6. The method of manufacturing a light emitting device according to claim 1, at least one of the first and second polymerizable groups including radical polymerization characteristics.

7. The method of manufacturing a light emitting device according to claim 1, the first carrier transporting compound including a hole transporting compound that includes a hole transporting portion having hole transporting characteristics, and the first carrier transporting compound including an electron transporting compound that includes an electron transporting portion having electron transporting characteristics.

8. The method of manufacturing a light emitting device according to claim 1, the second coated film being formed by a liquid phase process.

9. The method of manufacturing a light emitting device according to claim 1, a weight ratio between the second light emitting compound and the second carrier transporting compound being in a range from 1:100 to 90:10.

10. The method of manufacturing a light emitting device according to claim 1, at least one of the third and fourth polymerizable groups including a plurality of polymerizable groups.

11. The method of manufacturing a light emitting device according to claim 1, at least one of the third and fourth polymerizable groups including cationic polymerization characteristics.

12. The method of manufacturing a light emitting device according to claim 1, at least one of the third and fourth polymerizable groups including radical polymerization characteristics.

13. The method of manufacturing a light emitting device according to claim 1, the second carrier transporting compound including a hole transporting compound that includes a hole transporting portion having hole transporting characteristics, and the second carrier transporting compound including an electron transporting compound that includes an electron transporting portion having electron transporting characteristics.

14. The method of manufacturing a light emitting device according to claim 1, at least one of the first and second coated films including a host compound having a host portion for supplying excitation energy to the light emitting moiety.

15. The method of manufacturing a light emitting device according to claim 1, at least one of the first and second coated films including a host compound having a host portion for supplying excitation energy to the light emitting moiety, the host compound including a polymerizable group.

16. The method of manufacturing a light emitting device according to claim 1, at least one of the first and second coated films including a host compound having a host portion for supplying excitation energy to the light emitting moiety, the host compound including at least any one of an arylamine skeleton, a carbazole skeleton and a fluorene skeleton.

17. A method of manufacturing an electronic apparatus, comprising the method of manufacturing a light emitting device according to claim 1.
